(19) United States
(12) Patent Application Publication
(10) Pub. No.: US 2026/0289237 A1
(43) Pub. Date: Sep. 24, 2026

(54) SYSTEM

(71) Applicant: SoftBank Group Corp., Tokyo (JP)

(72) Inventor: Sayaka OSAWA, Tokyo (JP)

(73) Assignee: SoftBank Group Corp., Tokyo (JP)

(21) Appl. No.: 19/560,257

(22) Filed: Mar. 9, 2026

(30) Foreign Application Priority Data
Mar. 19, 2025 (JP) 2025-044899

(51) Int. Cl. G06N 3/045; G06F 18/2415; G06N 3/0475; G06N 3/048

(52) U.S. Cl. CPC G06N 3/045; G06F 18/2415; G06N 3/0475; G06N 3/048

(57) ABSTRACT

A system includes a processor that is configured to analyze input information from a user and generate a prompt that instructs generation of data necessary for information exchange, input the generated prompt into a generative artificial intelligence model to generate the data necessary for information exchange, and store the generated data in a recording device and transfer the generated data to a destination user.

### CROSS-REFERENCE TO RELATED APPLICATION

This application is based on and claims priority under 35 USC 119 from Japanese Patent Application No. 2025-044899 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information exchange systems, including messenger applications and communication platforms, generally rely on users to manually compose all content to be transmitted and to independently determine how to respond to communication needs. Such systems do not effectively support users who have difficulty formulating appropriate messages, who lack conversation topics, or who need structured or personalized information to be shared among multiple users. Furthermore, known systems do not sufficiently utilize generative artificial intelligence models through explicit prompting in order to flexibly generate data that matches a user's request or communication context. As a result, users face a burden in creating suitable content for information exchange, in generating shareable information based on specific requirements, and in detecting and engaging with recommended users that satisfy certain selection conditions and share common interests. There is therefore a need for a system that can automatically analyze user input, generate appropriate prompts for a generative AI model, obtain and store generated data required for information exchange, and provide this data to destination users, including in scenarios where information is to be shared among users or where recommended users must be detected based on selection conditions and common interests.

### SUMMARY

In order to solve the above-described problems, the present invention provides a system comprising a processor, wherein the processor is configured to analyze input information from a user and generate a prompt that instructs generation of data necessary for information exchange, input the generated prompt into a generative artificial intelligence model to generate the data necessary for information exchange, and store the generated data in a recording device and transfer the generated data to a destination user. In one aspect, the processor is configured to use a prompt that instructs generation of data in accordance with a request of a user, in order to analyze information and generate information to be shared among users, thereby enabling flexible creation of content that matches the users'needs and is suitable for distribution to multiple recipients. In another aspect, the processor is configured to use a prompt that instructs creation of information in order to detect a recommended user having a common interest in an environment that satisfies selection conditions of a user, and to generate information for communication with the recommended user. By employing prompts explicitly designed to direct the generative AI model, the system automatically produces context-appropriate, personalized data for information exchange, reduces the burden on the user in composing messages, and enhances the efficiency and quality of communication between users.
The term “processor” refers to any hardware, firmware, or combination thereof, including one or more CPUs, GPUs, microcontrollers, or dedicated circuits, that executes instructions to perform functions such as analyzing user input, generating prompts, interacting with a generative artificial intelligence model, and controlling storage and transfer of data.
The term “user” refers to an individual or entity that operates a terminal or client device to input information, request generation of data, receive generated data, or otherwise interact with the system for the purpose of information exchange.
The term “input information” refers to any data provided by a user to the system, including but not limited to text, selections, commands, parameters, profile data, or other signals that express the user's intent, request, or communication content.
The term “prompt” refers to a data structure, message, or instruction sequence generated by the processor and supplied to a generative artificial intelligence model, which specifies how the model should process information and what type of data should be generated.
The term “generative artificial intelligence model” refers to a machine learning model, such as a neural network-based language model or multimodal model, that generates new data (for example, text, structured data, or recommendations) in response to a given prompt.
The term “data necessary for information exchange” refers to any content generated by the generative artificial intelligence model that is intended to be communicated between users, including messages, suggestions, summaries, recommendations, or other information that facilitates communication.
The term “recording device” refers to any storage component or subsystem, including but not limited to a database, memory, or non-volatile storage unit, that stores generated data, prompts, user profiles, logs, or other information managed by the system.
The term “destination user” refers to a user who is designated as the recipient of data generated by the generative artificial intelligence model, and to whom the system transfers such data for viewing or further interaction.
The term “information shared among users” refers to data that is generated by the system in response to a user request and is made available to two or more users, such as group messages, shared summaries, common recommendations, or broadcast content.
The term “request of a user” refers to any instruction, preference, or query explicitly or implicitly provided by a user, including direct commands, menu selections, parameter settings, or behavior-based indications of desired content.
The term “selection conditions of a user” refers to criteria specified by or derived for a user, such as age range, interests, preferences, location, or other constraints, that are used to determine whether another user is suitable as a recommended user.
The term “environment that satisfies selection conditions of a user” refers to a situation, dataset, or system state in which candidate users and related information are available and can be filtered or evaluated based on the selection conditions specified by the user.
The term “recommended user” refers to a user identified by the processor as satisfying at least part of the selection conditions of another user and having at least one common interest or other relevant similarity that makes the user suitable for suggested interaction.
The term “common interest” refers to an interest, preference, hobby, or topic that is shared by at least two users, and which is used by the processor to detect recommended users and to generate information for communication between such users.
The term “creation of information” refers to the generation, by the generative artificial intelligence model under control of the processor, of new data or content, such as messages, introductions, topic suggestions, or other communication materials, based on prompts and underlying user data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

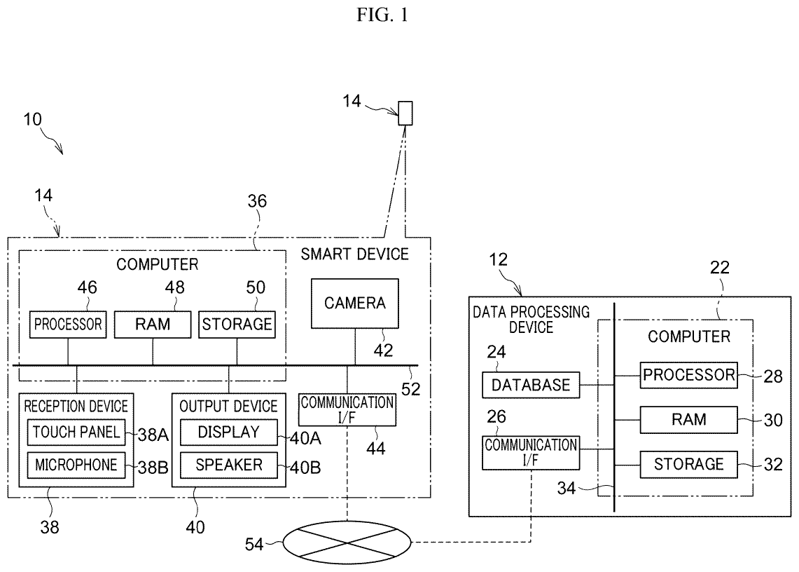

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

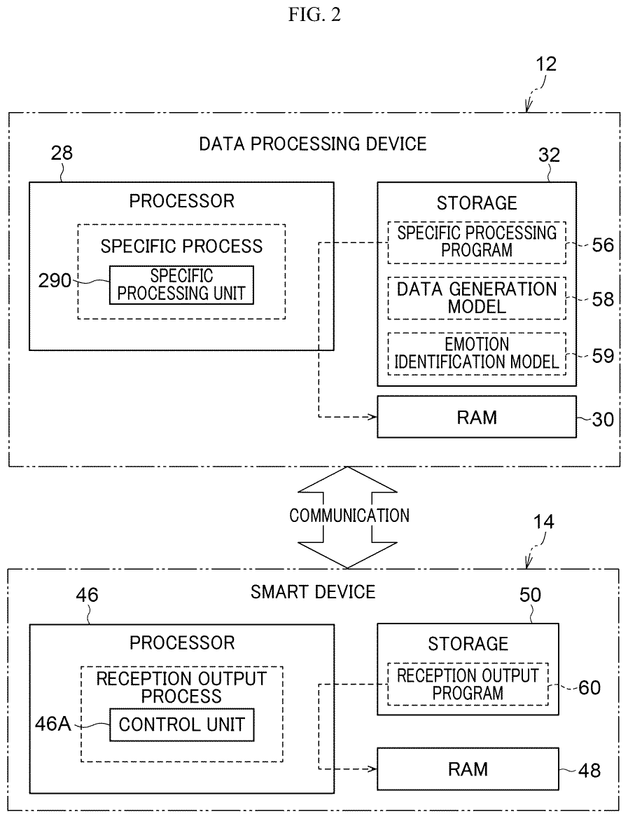

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information exchange systems that rely on messaging functions typically implement fixed, rule-based processing at the server and terminal sides. In such systems, a server generally receives message data from a terminal, stores the message data in a storage device, and forwards the message data to a destination terminal when a connection becomes available. Although this architecture supports basic communication, it exhibits several technical limitations from the perspective of computer technology.
First, conventional systems do not systematically integrate a generative artificial intelligence model into the core message processing pipeline at the protocol and storage levels. When such models are used, they are often invoked on an ad hoc basis at the application layer, without structured prompt generation based on message history and user state maintained in machine-manageable data structures. As a result, the server cannot automatically generate optimized responses, summary information, or recommendation content in a way that is tightly coupled with the low-level mechanisms of message routing, connection state management, and persistent storage. This leads to redundant network traffic, inefficient usage of processing resources, and limited adaptability of the system to dynamic communication contexts.
Second, conventional systems have limited ability to manage delivery timing of AI-enhanced content in relation to the connection state of users. Many systems perform straightforward store-and-forward operations, but do not maintain structured connection management information or message history information in a manner that allows the server to optimize when and how AI-generated information is delivered. For example, when a destination user is offline, existing systems may either drop AI-enhanced content, generate content redundantly at a later time, or deliver raw messages without leveraging generative processing, thereby increasing storage overhead and processing latency when the user reconnects.
Third, at the terminal side, conventional systems do not tightly integrate the reception, local storage, and visual presentation of AI-generated information in a way that reflects the internal state of a server-side information processing apparatus. Typical terminals merely render plain messages, and they neither preserve the association between AI-generated information and the underlying data structures maintained by the server nor support consistent synchronization of message history and user state information. This can cause inconsistencies between server state and terminal state, result in repeated computations on the server, and degrade the overall responsiveness and reliability of the information exchange process.

Moreover, systems that attempt to provide advanced features such as recommending other users with common interests or creating sharable content across multiple users often implement these features as separate subsystems that are not deeply integrated with the messaging pipeline or with a generative model. Such fragmentation prevents the server from performing coherent analysis of stored message history information and user attribute information, and from using the results as structured prompt sentences for a generative model. Consequently, the server cannot effectively leverage stored data to generate optimized recommendation information or shared content, and cannot control the distribution of such information based on real-time connection states and persistent user profiles.

Accordingly, there is a need for an improved computer-implemented system that integrates:
(i) structured prompt generation based on message content, message history, and user-related information; (ii) coordinated invocation of a generative artificial intelligence model as a backend processing component; (iii) robust management of user connection states and undelivered information; and (iv) consistent handling of AI-generated information on both server and terminal sides, including storage and visual presentation. Such a system should improve the efficiency, scalability, and reliability of information exchange while enabling new functionalities such as context-aware sharable content generation and interest-based user recommendation, implemented as concrete enhancements to the computer technology underlying messaging systems.

The specific processing by the specific processing unit 290 of the data processing device 12 in Example 1 is realized by the following means.

The present invention provides a server comprising a processor, a communication interface, a storage device, and an interface to a generative processing apparatus, the processor being configured to receive, via the communication interface, transmission request data including text information and destination identification information generated by a terminal, analyze the transmission request data to extract source user identification information, destination user identification information, and message content information, generate a structured prompt sentence that instructs the generative processing apparatus to generate information exchange data based on the message content information and user-related information stored in the storage device, input the prompt sentence into the generative processing apparatus, obtain the information exchange data generated by the generative processing apparatus in response to the prompt sentence, associate the information exchange data with message history information in a data structure, store the associated data in the storage device together with user state information, determine, based on the destination user identification information, a connection state of a destination user by referring to connection management information, transmit the information exchange data to a destination terminal by real-time communication control via the communication interface when the destination user is in a connected state, hold the information exchange data as undelivered information in the storage device when the destination user is in a disconnected state, and, upon establishment of a connection from the destination terminal, acquire the undelivered information from the storage device and transmit the undelivered information to the destination terminal. This enables a computer-implemented messaging infrastructure to systematically integrate generative artificial intelligence into the message processing pipeline, optimize storage and delivery of AI-generated information based on user connection states and stored histories, and thereby improve the technical performance, efficiency, and functionality of information exchange between terminals.
The term “system” refers to a combination of hardware and software components, including at least a processor, a communication interface, a storage device, and a display device, that cooperate to perform information exchange processing between users.
The term “processor” refers to a hardware computation unit, such as a central processing unit or an execution core, that executes machine-readable instructions to control communication, data analysis, data storage, and user interface operations within the system.
The term “communication interface” refers to a hardware and software communication module, such as a network adapter and associated protocol stack, that enables data transmission and reception between the system components and external devices over wired or wireless communication networks.
The term “storage device” refers to a non-transitory computer-readable medium, such as a semiconductor memory, a magnetic disk, or a solid-state drive, that stores message data, user-related information, connection management information, and information exchange data.
The term “display device” refers to an output apparatus, such as a screen, a monitor, or a touch panel, that visually presents information including input display areas, conversation display areas, and notification information to a user.
The term “terminal” refers to an information processing apparatus operated by a user, such as a portable device or a personal computer, that provides a user interface for inputting, transmitting, receiving, storing, and displaying message-related information.
The term “information processing apparatus” refers to a server-side computing entity, implemented by one or more processors and memories, that receives transmission request data from terminals, analyzes such data, interacts with a generative processing apparatus, manages storage, and controls delivery of information exchange data.
The term “generative processing apparatus” refers to a computing component, such as a generative artificial intelligence model executed on hardware, that generates information exchange data, sharable content, or recommendation data in response to an input prompt sentence.
The term “prompt sentence” refers to a structured instruction expressed as machine-processable text that is generated by the processor and provided to the generative processing apparatus to specify the content, conditions, or purpose of data to be generated.
The term “information exchange data” refers to data generated by the generative processing apparatus or by the information processing apparatus, including messages, responses, summaries, recommendations, or other communication-related content used in exchanges between users.
The term “transmission request data” refers to data generated by a terminal, including at least text information and destination identification information, that indicates a user's request to transmit a message or initiate an information exchange.
The term “text information” refers to character-based content input by a user, such as words, phrases, or sentences, which is included in transmission request data and may serve as a basis for generating information exchange data.
The term “destination identification information” refers to data that uniquely or logically identifies a target user or a target terminal, such as a user identifier, an account identifier, or an address, to which information exchange data is to be delivered.
The term “source user identification information” refers to data that identifies a user who originates message content or transmission request data, and that is used to associate messages and histories with a particular user.
The term “message content information” refers to information representing the substantive content of a message, including text information and, optionally, associated metadata, that is extracted and processed by the information processing apparatus.
The term “user-related information” refers to information associated with a user, including at least user attribute information, interest attribute information, environment condition information, and message history information stored in the storage device.
The term “message history information” refers to stored records of past messages and related states, including sender, recipient, timestamps, content, and delivery status, managed in association with users or conversations.
The term “user state information” refers to data representing the current or recent status of a user or terminal, such as connection state, activity state, or presence state, which is used to control timing and manner of information delivery.
The term “connection management information” refers to data structures maintained by the information processing apparatus that record connection states, session information, or communication channels associated with users or terminals.
The term “connected state” refers to a condition in which a destination terminal or user has an active communication session or reachable communication channel with the information processing apparatus through the communication interface.
The term “disconnected state” refers to a condition in which a destination terminal or user does not have an active communication session or is not currently reachable by the information processing apparatus through the communication interface.
The term “undelivered information” refers to information exchange data that has been generated and stored in the storage device but has not yet been successfully transmitted to, or confirmed as received by, a destination terminal.
The term “local storage” refers to a storage resource provided within or directly attached to a terminal, such as a local memory or local non-volatile storage, used to store received information exchange data and message history.
The term “input display area” refers to a region on the display device controlled by the terminal that allows a user to input text information, such as a text box or an editable field, and to invoke message transmission operations.
The term “conversation display area” refers to a region on the display device that visually presents messages, information exchange data, or histories of interactions between users in chronological or structured form.
The term “notification process” refers to processing performed by the terminal or system to alert a user to receipt or availability of information exchange data, including operations such as displaying a notification, playing a sound, or triggering a visual indicator.
The term “user attribute information” refers to data describing characteristics of a user, such as profile information, demographic attributes, preferences, or roles, stored in association with a user in the storage device.
The term “interest attribute information” refers to data indicating topics, categories, or themes of interest associated with a user, which can be used to evaluate similarity between users and to generate recommendation data.
The term “environment condition information” refers to data representing contextual conditions related to a user or terminal, such as location conditions, time conditions, device type, or usage context, stored for analysis and recommendation.
The term “shared-target information” refers to information derived from multiple message history records and user attribute data that indicates common topics, resources, or contexts suitable for generation of sharable content among multiple users.
The term “data for sharing” refers to information generated by the generative processing apparatus based on shared-target information, designed to be distributed to multiple users for common viewing, usage, or interaction.
The term “recommended users” refers to users identified by the information processing apparatus, based on evaluation of similarity using interest attribute information and environment condition information, as suitable candidates for mutual information exchange.
The term “recommended-user data” refers to information generated by the generative processing apparatus for or about recommended users, including introductions, suggestions, or communication prompts that promote information exchange between such users.

The term “evaluation processing regarding similarity” refers to computation performed by the pr1ocessor using at least interest attribute information and environment condition information to calculate similarity measures or scores between users.
The term “real-time communication control” refers to control processing for transmitting information exchange data with minimal delay through active communication channels, such as bidirectional communication links or session-based connections, while reflecting the current connection state of users.

In one embodiment, the system includes a server, a plurality of terminals, a communication network, at least one storage device, at least one display device, and a generative AI model executed on a computing platform connected to the server. The server and each terminal include one or more processors, volatile and non-volatile memories, and a communication interface. The server and the terminals execute programs stored in the memories to perform information exchange processing between users.

The terminal operates as a client device, such as a smartphone, a tablet computer, or a personal computer. The terminal uses an operating system, such as a mobile operating system or a desktop operating system, and an application framework providing a graphical user interface. The terminal provides an input display area implemented by a text input component and displays a conversation display area implemented by a scrollable list component. The terminal uses a network communication library, such as an HTTP client library or a WebSocket client library, to transmit and receive data with the server.

The server operates as an information processing apparatus, such as a physically separate machine or a cluster of machines, executing a server operating system and an application framework, such as a web framework or a real-time communication framework. The server uses a web server program to accept HTTP or WebSocket connections, a database management system to store data on the storage device, and an inter-process communication mechanism to interact with the generative AI model.

The server stores message history information, user attribute information, connection management information, and information exchange data in relational tables or structured key-value records. An example relational schema includes a messages table with columns for message identifier, source user identifier, destination user identifier, message content, timestamps, and delivery status, a users table with columns for user identifier and profile attributes, an interests table with interest attributes per user, and a sessions table with connection state per user.

The server uses a generative AI model as a generative processing apparatus. In one embodiment, the generative AI model includes a transformer-based neural network with multiple self-attention layers, feedforward layers, and layer normalization components. The generative AI model is trained on text data representing conversational interactions and user preference descriptions. The generative AI model receives a prompt sentence tokenized into discrete tokens, maps the tokens to embedding vectors, applies multi-head self-attention operations to compute context-aware representations, and outputs a sequence of tokens representing generated text. The server invokes the generative AI model through a model-serving interface, which may run on a dedicated computing node with an accelerator, such as a graphics processing unit.

The server trains the generative AI model using supervised learning and optionally fine-tunes the model on domain-specific message history data. The server uses a loss function, such as cross-entropy between predicted tokens and ground-truth tokens, and updates model weights using an optimization algorithm, such as stochastic gradient descent or an adaptive gradient method. The server may apply data augmentation by masking parts of input texts or by reordering segments to make the model robust to variations in message patterns. By fine-tuning the generative AI model on message history information and user attribute information, the server adapts the model to the particular system context and improves the accuracy and relevance of generated information exchange data.

The server generates a prompt sentence as a structured instruction that encodes message content information, user-related information, and a requested output type. For example, the server uses a prompt sentence such as:
“Generate a concise and polite reply to the following message from user A to user B: ‘Hello, how are you?’ The reply should maintain a friendly tone and be appropriate for a casual conversation.”

In another example, the server uses a prompt sentence such as:
“Based on the past 20 messages exchanged between user A and user B, summarize the main topic of their discussion in one sentence that can be shown as a chat preview.”

In still another example, the server uses a prompt sentence such as:
“From the stored interaction histories and interest profiles of user A and user C, describe one common interest and propose a short introductory message that encourages them to start a conversation.”

The server constructs such prompt sentences by concatenating current message content, selected prior messages retrieved from the messages table, and user attribute data retrieved from the users and interests tables. The server encodes message identifiers, timestamps, and roles (sender or recipient) into textual markers inside the prompt sentence, enabling the generative AI model to interpret temporal and relational structure that is not ordinarily exposed in human-readable form.

The server differs from a manually operated system because the server does not simply mirror human drafting of responses. The server uses non-conventional data structures and rules to create prompt sentences that capture internal server state, connection state, and message history in machine-optimized formats. For example, the server selects a fixed-size sliding window of prior messages based on a time-based and content-based heuristic, rather than simply taking the last N messages, in order to control input length and reduce computational load while preserving key semantic transitions. This selection algorithm computes term frequency scores and recency weights for each message content segment and discards segments that contribute little to semantic context, thereby reducing the size of prompts and improving inference speed.

The server uses the generative AI model output as information exchange data and does not treat it as a direct human instruction. The server post-processes the generated tokens by applying rule-based filters, truncation rules, and length constraints determined by the server's resource usage policies. For instance, the server restricts the maximum number of tokens in a generated reply and normalizes whitespace and encoding to suit the storage and communication protocols. This post-processing step reduces unnecessary payload size and prevents excessive computation at terminals, thereby improving communication efficiency and terminal-side rendering performance.

The server uses connection management information in a dedicated data structure, such as an in-memory table indexed by user identifier, holding fields such as current connection channel identifier, protocol type, and last activity timestamp. The server updates this table whenever a terminal establishes or closes a session. By using this data structure, the server can determine whether to send information exchange data through a persistent real-time channel or to store the data as undelivered information.

The server stores undelivered information in the storage device with status flags indicating that the information has not been pushed to a destination terminal. The server uses an index on destination user identifier and status flag to rapidly retrieve pending information when a terminal reconnects. This indexing reduces query latency and improves responsiveness when multiple users come online simultaneously.

The terminal uses local storage to keep a local copy of information exchange data and message history. The terminal uses a structured local database, such as a relational or key-value store, to associate each message with identifiers allocated by the server and with local synchronization markers. The terminal uses an update policy that compares server-supplied timestamps and version numbers with local records to avoid duplication and to correct inconsistencies. Because of this synchronization mechanism, the terminal can display a consistent conversation history even under fluctuating network conditions.

The terminal displays information exchange data in a conversation display area. The terminal arranges message items according to server-provided timestamps and message identifiers, which prevents out-of-order rendering that can occur when network packets arrive with variable delays. The terminal may visually distinguish AI-generated information from user-entered messages through layout or style differences, but both forms of information are stored and processed using the same technical infrastructure.

The server uses the generative AI model not only for generating direct responses but also for generating sharable information across multiple users and recommendation information about potential communication partners. For sharable information, the server analyzes message history information of multiple users and user attribute information to derive shared-target information. The server computes, for example, co-occurrence statistics of topic keywords across users and stores such statistics as feature vectors. The server then uses a prompt sentence such as:
“Using the following topics frequently discussed among users X, Y, and Z: [list of topics], generate a short shared announcement that summarizes these topics and invites all of them to participate in a group discussion.”

For recommendation information, the server computes similarity scores between pairs of users using interest attribute information and environment condition information. The server represents user interests as multi-dimensional vectors and calculates similarity by cosine similarity or another distance measure. The server then selects user pairs whose similarity exceeds a threshold. The server uses a prompt sentence such as:
“User A and user C both show strong interest in ‘outdoor activities’and ‘photography’. Generate a short introduction message that suggests they might enjoy sharing their experiences and recommends a conversation starter.”

By embedding similarity results and interest attributes into prompt sentences, the server enables the generative AI model to produce recommendation data specifically tailored to computed relationships, rather than generic suggestions. As a result, technical resources for recommendation processing become more efficient, because the server narrows down candidate users by pre-computed metrics before invoking the generative AI model.

The server thus provides an improvement of computer technology beyond simple automation of human tasks. The server reduces communication bandwidth by filtering and summarizing stored messages into compact, AI-generated information exchange data. The server reduces server-side computation by constraining prompt size and employing optimized retrieval and selection of relevant past messages. The server improves data management by using structured tables and indices that directly support generative AI invocation, connection state tracking, and undelivered information management.

The server further improves accuracy and consistency of communication by using training and fine-tuning procedures that adapt the generative AI model to system-specific message patterns and user attributes. Because the server trains the generative AI model with domain-relevant histories and custom loss functions that penalize incoherent or off-topic outputs, the system can generate more contextually appropriate responses than generic, unadapted models. This reduces error rates in generated messages and decreases the need for retransmissions or manual corrections.

The server uses an internal module architecture including a communication module, a message analysis module, a prompt generation module, a generative inference module, a storage management module, a connection management module, and a delivery control module. Each module communicates through defined data structures and function interfaces. The message analysis module converts raw message payloads from the communication module into canonical message objects stored in message queues. The prompt generation module constructs prompt sentences by reading message objects and user state records. The generative inference module encapsulates calls to the generative AI model and returns generated token sequences. The storage management module writes message objects and generated outputs into persistent storage with transactional guarantees. The connection management module updates online/offline status of users, and the delivery control module decides routing and timing of message delivery based on connection states.

In alternative embodiments, the server may deploy different types of generative AI models, such as sequence-to-sequence encoder-decoder networks, recurrent neural networks, or hybrids of transformer and convolutional architectures. The server may adjust layer counts, hidden dimensions, and attention heads depending on deployment constraints. The server may also use different optimization algorithms, such as second-order methods or gradient clipping strategies, to stabilize training for highly variable conversational data. In another variation, the server may maintain multiple generative AI models specialized for different tasks, such as short replies, long summaries, or recommendation messages, and the server may select a model by examining metadata in the prompt sentence.

In another embodiment, the terminal may implement partial local inference by hosting a lightweight generative model fine-tuned on a subset of data, where the server sends compressed model updates at scheduled intervals. In such a configuration, the server still manages global histories and connection management, while the terminal locally generates low-latency suggestions or draft replies, which are then refined or validated by the server-side generative AI model. This division of labor can reduce latency perceived by the user and offload some workload from the server.

In still another embodiment, the storage device may be distributed across multiple physical nodes, and the server may use a distributed transaction protocol to ensure consistency of message history information and user attribute information. The server may use sharding based on user identifier or conversation identifier to distribute load, and the modules responsible for prompt generation and generative inference may consult multiple shards to assemble a coherent context for each prompt sentence.

By integrating these hardware components, data structures, and algorithmic processes, the server, the terminal, and the generative AI model cooperate to provide a technically improved messaging infrastructure. The integration of structured prompt generation, model-based generation, connection-aware delivery control, and optimized storage management causes concrete effects such as improved throughput, reduced communication load, more accurate and relevant generated content, and robust synchronization between server-side and terminal-side states, thereby enabling reliable and efficient implementation of the claimed system in practical environments.

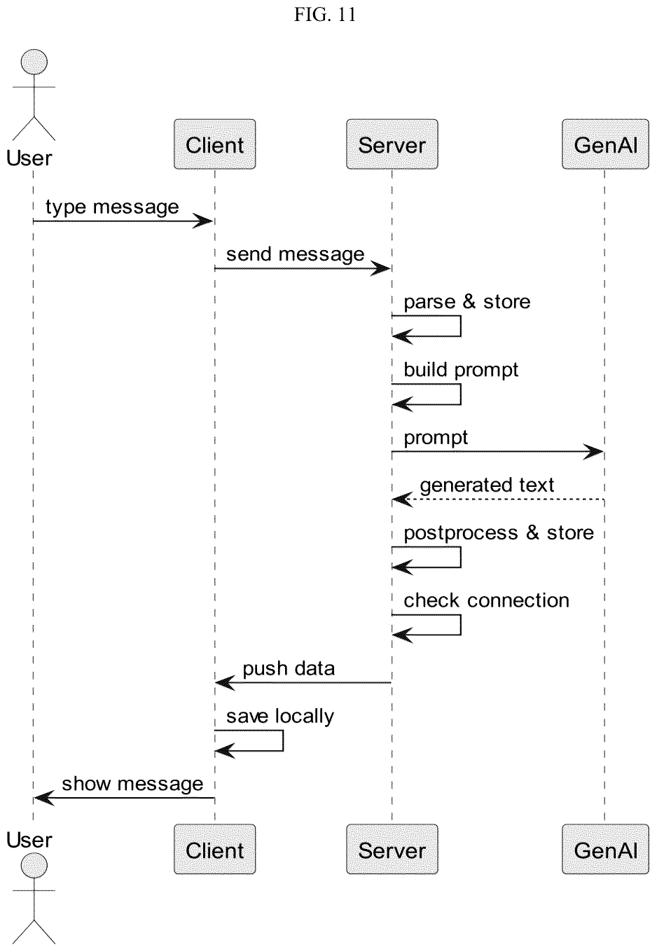

The following describes the processing flow using FIG. 11.

### Step 1:

The user operates the terminal to input a message.

The user touches a text input area displayed on the terminal, enters character strings such as “Hello, how are you?”, and then taps a send button rendered by the terminal.

The input of this step is the user's keystrokes and touch events on the display device. The terminal converts these low-level events into a text string and associated metadata, such as a local timestamp and a destination user identifier selected in the user interface.

The terminal outputs an internal message object that includes at least a source user identifier, a destination user identifier, message content information, and a local creation time. The terminal performs data processing by concatenating characters into a string buffer, validating that the string is non-empty, attaching the identifiers, and constructing a structured object in memory.

### Step 2:

The terminal generates transmission request data and prepares it for network transmission.

The terminal receives the internal message object as input. The terminal serializes the message content information, the source user identifier, and the destination user identifier into a structured data representation suitable for a communication protocol, for example, key-value pairs in a message body.

The terminal attaches protocol-specific headers, such as content type and authentication tokens, and computes a checksum or length field as required by the communication library. T

he terminal outputs transmission request data that includes a header part and a body part.

The terminal thereby transforms an in-memory object into a byte sequence using a defined encoding (for example, UTF-8) and prepares the data for transmission through the communication interface.

### Step 3:

The terminal transmits the transmission request data to the server over the communication network.

The input of this step is the transmission request data generated in Step 2. The terminal uses a network stack to open or reuse a communication channel, such as an HTTP or WebSocket connection, to the server's network address. The terminal writes the byte sequence representing the transmission request data into a network socket, and the operating system segments the data into packets and sends them over the physical interface.

The output of this step is the delivery of the transmission request data to the server side, together with protocol metadata such as source address and session information. As a data operation, the terminal encapsulates the request in protocol frames, applies encryption if a secure protocol is used, and triggers retransmission control mechanisms at the transport layer.

### Step 4:

The server receives the transmission request data and reconstructs the logical request.

The server accepts incoming packets at a listening port via the communication interface. The input of this step is the network-level representation of the transmission request data captured by the server's network stack. The server reassembles packets into a complete protocol message, terminates any encryption, and parses the protocol headers to identify the type of request and the associated user session.

The server outputs a reconstructed logical request object that contains the source user identifier, the destination user identifier, and the raw message body as a text string or structured fields. The server performs data processing by decoding the byte stream, validating protocol fields, and mapping the content into internal data structures.

### Step 5:

The server analyzes the transmission request data to extract message content information and user identifiers.

The server uses the logical request object from Step 4 as input. The server parses the body of the request, identifies fields for source user identification information, destination user identification information, and message content information, and verifies that required fields are present and valid.

The server may apply string length checks and character set validation to the message content information, and may strip unsupported control characters. The output of this step is a normalized message record in memory, containing clean text content, normalized user identifiers, and associated timestamps. The server thus transforms raw request text into a canonical internal representation suitable for storage and further processing.

### Step 6:

The server stores the message record and updates message history information.

The input of this step is the normalized message record produced in Step 5. The server converts the in-memory fields into a database insertion command and writes a new row into a message history table on the storage device. The server may also update indexes and conversation-level metadata, such as last message timestamp per conversation.

As data processing, the server maps logical values to database columns, calculates a new message identifier, and ensures referential integrity with user tables. The output of this step is persistent message history information stored in the storage device, including the new row and updated indexes that allow efficient retrieval by user or conversation identifier.

### Step 7:

The server prepares user-related information and message context for prompt generation.

The server takes as input the newly stored message record and previously stored message history information and user attribute information. The server queries the storage device to retrieve a set of recent messages associated with the same pair or group of users, and retrieves user profiles and interest attributes.

The server then applies a selection algorithm to limit the number of context messages, for example, by computing recency scores and topic relevance scores, and discarding low-relevance entries. The output of this step is a compact context set consisting of selected prior messages and user-related attributes. The server thereby transforms a large volume of stored data into a focused subset that will be embedded into a prompt sentence, reducing computational load for later processing.

### Step 8:

The server generates a prompt sentence for the generative AI model.

The input of this step is the compact context set and the current message content information. The server formats the selected prior messages, user identifiers, and attribute descriptors into a textual instruction that conforms to a predefined template. For example, the server constructs a prompt sentence such as:
“Generate a concise and polite reply to the following message from user A to user B: ‘Hello, how are you?’ The reply should maintain a friendly tone and be appropriate for a casual conversation.”

The server may also construct other types of prompt sentences, such as:
“Based on the past 20 messages exchanged between user A and user B, summarize the main topic of their discussion in one sentence that can be shown as a chat preview.”

The server performs string concatenation, insertion of markers indicating role and time, and escaping of special characters to ensure the generative AI model interprets the input correctly. The output of this step is a complete prompt sentence as a single text string ready for tokenization.

### Step 9:

The server invokes the generative AI model to obtain information exchange data.

The input of this step is the prompt sentence from Step 8. The server tokenizes the prompt sentence into discrete tokens using a tokenizer that maps character sequences to integer identifiers. The server sends the token sequence to the generative AI model, which executes on a computing platform with a processor or accelerator.

Within the generative AI model, multiple layers process the token embeddings using self-attention and feedforward computations. The server receives as output a sequence of generated tokens that represent a reply, a summary, or recommendation content. The server then detokenizes the sequence into a text string. The output of this step is information exchange data in textual form, such as a generated reply message or a summary sentence, computed through numerical operations on matrices and vectors inside the model.

### Step 10:

The server post-processes the generated information exchange data and associates it with message history information.

The input of this step is the raw generated text from Step 9 and the message record from Step 6. The server applies length constraints, removes or replaces prohibited patterns, and normalizes formatting, such as trimming whitespace and standardizing line breaks.

The server then creates a new data structure that links the generated content to the original message identifier and to the involved user identifiers. The output of this step is a cleaned and linked information exchange record in memory, prepared for storage and delivery. This record includes the generated text, references to related messages, and metadata such as generation time and model identifier.

### Step 11:

The server stores the information exchange data and updates user state and history.

The input of this step is the linked information exchange record created in Step 10. The server writes the generated content and associated metadata into the storage device, for example, into a dedicated table for AI-generated messages or into extended columns of the existing message history table.

The server updates user state information, such as unread message counts or last AI-generated update timestamps. The output of this step is persistent storage of the generated information exchange data, with updated indexes and state values that support efficient retrieval and consistent user interface display in later steps.

### Step 12:

The server determines the destination user's connection state based on connection management information.

The input of this step is the destination user identifier from the message record and the connection management information stored in memory or in a fast-access storage structure. The server looks up the destination user identifier in a connection table that holds fields such as current session identifier, protocol type, and online/offline status.

The server evaluates time-based thresholds and recent activity indicators to classify the user as being in a connected state or a disconnected state. The output of this step is a connection state flag and, in the connected case, a handle for a live communication channel to the destination terminal. This decision informs the subsequent routing of the information exchange data.

### Step 13:

The server routes the information exchange data according to the connection state.

The input of this step is the connection state flag from Step 12 and the stored information exchange record from Step 11. If the server determines that the destination user is in a connected state, the server sends the generated information over a real-time communication channel, such as a persistent socket, using a message envelope that includes the message identifier and content. If the server determines that the destination user is in a disconnected state, the server marks the information exchange data as undelivered and retains it in the storage device without immediate transmission.

The output in the connected case is a transmitted message over the network to the destination terminal. The output in the disconnected case is an updated database record with an undelivered status flag, enabling later retrieval when the terminal reconnects. The server thereby transforms state information into concrete routing actions that control network usage.

### Step 14:

The terminal of the destination user receives information exchange data from the server when connected.

The input of this step is the transmitted message envelope arriving through the terminal's communication interface. The terminal decodes the protocol frames, extracts the payload, and parses fields containing message identifiers and content.

The terminal validates message integrity, for example, by checking a checksum or message length, and then constructs a local message object representing the received information exchange data. The output of this step is a structured local representation of the new message stored temporarily in the terminal's memory, ready for storage and display.

### Step 15:

The terminal stores the received information exchange data in local storage.

The input of this step is the local message object from Step 14. The terminal inserts the message into a local database or key-value store, associating it with the conversation and recording the receipt time and synchronization markers.

The terminal may compare server-provided timestamps and version numbers with existing local entries to avoid duplication and to maintain ordering. The output of this step is an updated local message history that mirrors the server-side state and that supports offline access by the user.

### Step 16:

The terminal updates the conversation display area and notifies the user.

The input of this step is the newly stored local message record from Step 15. The terminal retrieves the relevant conversation messages from local storage, sorts them by timestamp and identifier, and constructs a visual layout for the conversation display area.

The terminal renders the generated message content as a new message item on the display device and may use a distinct style to indicate that it was generated by the system. The terminal then triggers a notification process, such as showing a notification banner or playing a sound. The output of this step is an updated visual representation of the conversation, combined with a user-visible alert, which enables the user to perceive and react to the new information exchange data.

### Step 17:

The user observes the generated content and optionally initiates a new interaction.

The input of this step is the updated conversation display on the terminal. The user visually inspects the generated reply, summary, or recommendation message, and can decide to input a new message or act on a recommendation, such as connecting with a recommended user.

In this step, there is no machine-generated data output, but the user's subsequent actions, such as new message input, become new inputs to Step 1, thereby closing the loop of interaction and leveraging the generative AI model iteratively in the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented communication systems, processors typically treat user messages as isolated text inputs and apply rule-based or generic response generation logic. Such systems often fail to detect when a user is in a stalled conversational state, for example when the user lacks a clear conversation opener or cannot identify an appropriate topic to continue an exchange. As a result, the systems either remain idle or return generic suggestions that are poorly aligned with the user's context and preferences, thereby degrading the efficiency and usability of the human-computer interaction.

Moreover, existing architectures typically invoke generative models in an ad hoc manner, without a structured prompt construction process that integrates multi-layered context such as past usage history, recent dialogue history, and current input content. This unstructured invocation leads to outputs that are difficult for the processor to parse and reuse programmatically, forcing additional heuristic post-processing or manual curation.

Consequently, system resources are consumed inefficiently, latency increases, and it becomes difficult to scale the system while maintaining high-quality, contextually appropriate responses.

Furthermore, many conventional systems handle recommendation logic and link metadata extraction as separate modules, disconnected from the conversational context and from each other. Recommendation engines are often optimized purely for content ranking without taking into account the immediate conversational state, and link preview functions are limited to static metadata extraction. These separate components do not operate in an integrated pipeline driven by a unified prompt to a generative model, and thus cannot efficiently produce coherent outputs that simultaneously address conversation continuation, user preference alignment, and information resource summarization.

In addition, existing systems frequently rely on unstructured natural language outputs from generative models, which lack a machine-readable format suitable for deterministic parsing by downstream components. When the model output is not constrained to a structured format, the processor must expend additional computational resources to infer the meaning and structure of the output, leading to errors, inconsistent behavior, and reduced reliability of the overall system. This limits the ability of the computer system to flexibly combine generated topics, recommendation information, and link-related display data into a unified response that can be efficiently rendered on a user terminal.

Accordingly, there is a need for an improved computer-implemented system that: (i) programmatically detects, using a processor, when a user is likely to lack a conversation opener; (ii) constructs and uses a context-rich prompt sentence to a generative AI model so that the model can simultaneously generate conversation topics, information-exchange data, and recommendation information tailored to the user; (iii) integrates link analysis and additional information extraction within the same processing pipeline; and (iv) constrains the generative model output to a machine-readable structured format that can be parsed and presented efficiently. Such a system would improve the functioning of the underlying computer technology by reducing processing overhead, enabling more accurate and scalable response generation, and enhancing the efficiency of data handling between a server and user terminals.

The specific processing by the specific processing unit 290 of the data processing device 12 in Application Example 1 is realized by the following means.

The present invention provides a server comprising a processor and a storage device that store instructions which, when executed by the processor, cause the processor to analyze character information acquired from a user terminal and determine, based on the character information and a past usage history of a user, whether the user is in a situation in which the user lacks a conversation opener; construct a context-rich prompt sentence including instructions to generate, by a generative AI model, both a topic serving as a conversation opener and data to be used for information exchange, the prompt sentence hierarchically describing context information including the past usage history, recent dialogue history, and current input character information; input the prompt sentence to the generative AI model to cause the generative AI model to simultaneously generate a plurality of candidate topics, information-exchange data, and recommendation information consistent with a preference of the user, the prompt sentence further specifying a machine-readable structured output format; acquire the past usage history from an information accumulation device and extract recommendation information based on the output of the generative AI model and the past usage history; analyze reference information indicating a location of an information resource included in the character information, acquire additional information from the corresponding information resource, and generate display data for presenting the additional information on the user terminal; parse, in accordance with the specified output format, a generation result output from the generative AI model to distinguish the topic, the information-exchange data, the recommendation information, and the display data; and store and transfer the distinguished outputs to the user terminal in an integrated response. This enables an improvement in computer functionality by allowing the server to more efficiently detect conversational stall states, to orchestrate a generative AI model through structured prompt sentences, to obtain machine-readable multi-component outputs that can be deterministically parsed, and to deliver coherent, context-aware topics, recommendations, and link-related display data to the user terminal with reduced processing overhead and improved response quality.
The term “processor” refers to a hardware information processing unit, such as a central processing unit or an execution core of an information processing apparatus, that executes instructions to perform analysis, determination, generation, and control operations described in this specification.
The term “storage device” refers to a non-transitory computer-readable recording medium, such as a semiconductor memory, magnetic storage, or optical storage, that stores instructions and data used by the processor.
The term “user terminal” refers to an information processing apparatus operated by a user, such as a portable communication device, a computing device, or a display-equipped input device, that transmits character information to the server and receives information for presentation to the user.
The term “character information” refers to text data included in input from the user terminal, including natural language sentences, symbols, and character sequences that express messages, queries, or other content.
The term “past usage history” refers to data indicating previous interactions of a user with the system, including past messages, accessed resources, selected recommendations, and other recorded behavior information stored over time.
The term “situation in which the user lacks a conversation opener” refers to a state, determined by the processor based on character information and past usage history, in which the user is inferred to lack a suitable topic or starting point to continue or initiate a communication.
The term “conversation opener” refers to a topic or content element that can serve as a starting point or trigger for initiating or continuing an exchange of information between users or between a user and the system.
The term “topic” refers to a subject, theme, or content item generated by the system that can be used as a basis for conversation or information exchange.
The term “data to be used for information exchange” refers to information generated by the system, including textual data, identifiers, and structured content, that can be transmitted between the user terminal and other terminals to support communication.
The term “prompt sentence” refers to text or structured input provided to a generative AI model, the text including instructions, context information, and constraints that control the type, content, and format of output generated by the generative AI model.
The term “context information” refers to information describing circumstances related to a user or a conversation, including past usage history, recent dialogue history, and current input character information, which is used to construct the prompt sentence.
The term “recent dialogue history” refers to a sequence of messages or exchanges occurring within a predetermined time or turn window prior to current character information, used as part of context information for processing.
The term “generative AI model” refers to a machine learning model, such as a neural network model trained to generate text or other data, that produces output content in response to a prompt sentence provided as input.
The term “generation result” refers to output data produced by the generative AI model based on a prompt sentence, including topics, information-exchange data, recommendation information, and other generated content.
The term “recommendation information” refers to information indicating one or more items, resources, or topics selected or ranked in accordance with a preference of the user, derived from the generation result and past usage history.
The term “preference of the user” refers to a characteristic or tendency of a user inferred from past usage history, such as favored categories, frequently selected items, or recurring interest patterns.
The term “information accumulation device” refers to a storage subsystem or database system that records and manages past usage history and related data for one or more users.
The term “reference information” refers to data included in character information that indicates a location or identifier of an information resource, such as a network address, link, or resource identifier.
The term “information resource” refers to digital content accessible via the reference information, including documents, media files, web pages, and other machine-readable data sources.
The term “additional information” refers to metadata or derived information obtained from an information resource, including titles, descriptions, summaries, identifiers, and other attributes associated with the resource.
The term “display data” refers to data formatted for presentation on the user terminal, including layout information, textual content, and associated attributes that enable visual or other perceptual output to the user.
The term “machine-readable structured format” refers to an output data format, such as a key-value structure, list, or hierarchical representation, that can be deterministically parsed and processed by the processor without natural language interpretation.
The term “integrated response” refers to a combined output including at least one topic, information-exchange data, recommendation information, and display data, which is generated and transmitted by the server to the user terminal as a unified set of information.

In one embodiment, server includes a processor, a main memory, a non-transitory storage device, a network interface, and an interface to an information accumulation device that stores past usage history for multiple users. Server is implemented, for example, as a rack-mounted computing apparatus equipped with a multi-core central processing unit and, in some embodiments, one or more graphics processing units. Server executes an operating system such as a general-purpose server operating system and runs application software implemented in a programming language interpreter or runtime environment such as a server-side runtime. Server is connected through a packet-based communication network to terminal operated by user.

Terminal includes a processor, a display, an input device, a communication module, and a local memory. Terminal is implemented, for example, as a portable communication device, a tablet, or a desktop computing device. Terminal executes a client application such as a native application or a web browser that presents a chat-style user interface to user. Terminal transmits character information entered by user to server via a secure communication protocol, and displays response data, including topics, recommendation information, and display data, received from server.

User operates terminal to input natural language messages in the form of character information. User may, for example, input “Any good movies recently?” or may include a network address such as “https://example.com/review” within a message. User sends the message from terminal to server by activating a transmission control in the user interface.

Server receives character information from terminal via the network interface and stores the character information in storage device in association with a user identifier and a time stamp. Server maintains a data structure for each user that represents past usage history. In one embodiment, server represents past usage history as a set of records in a relational schema including a user table, a message table, a recommendation interaction table, and a link interaction table. Each record in the message table includes a message identifier, a user identifier, a time stamp, a text field containing character information, and a conversation identifier. Each record in the recommendation interaction table includes a user identifier, an item identifier, a recommendation type, and a selection flag. Each record in the link interaction table includes a user identifier, a resource identifier, and interaction metrics.

Server analyzes character information using a natural language processing pipeline implemented in a software library such as a transformer-based text processing framework. Server tokenizes the character information, maps tokens to embeddings using a pre-trained embedding model, and applies a classifier implemented as a transformer encoder network. The classifier includes multiple self-attention layers, feed-forward layers, layer normalization, and nonlinear activation functions. The classifier outputs a probability distribution over a set of labels including at least a label representing a situation in which user lacks a conversation opener.

Server determines that user is in the situation in which user lacks a conversation opener when a probability value associated with that label exceeds a predetermined threshold. Server additionally reads recent dialogue history for the same conversation identifier from the message table and forms a context window of previous exchanges. Server represents the context window as a sequence of tokenized utterances concatenated with special separator tokens and computes an aggregate context embedding using the transformer encoder.

Server accesses information accumulation device, which may be a database system or a distributed storage system, to obtain past usage history for the user. Server aggregates the past usage history into a preference representation. In one embodiment, server constructs an interest vector by averaging or weighting item embeddings associated with content previously consumed or positively interacted with by the user. Item embeddings are generated by applying a sentence-level embedding model, such as a transformer network trained to map textual descriptions of items to a continuous vector space. Server stores the interest vector in a user profile table for reuse in subsequent processing.

Server constructs a prompt sentence for a generative AI model using the context embedding, the interest vector, and the current character information. Server formats the prompt sentence as multi-line natural language text that hierarchically describes context information. In one embodiment, server generates a prompt sentence such as:
“User's past viewing history: Movie A (science fiction), Movie B (time-travel thriller), Movie C (space exploration drama).
User's current message: ‘Any good movies recently?’
Please recommend three movies that match the user's interests. For each movie, provide the title and a one-sentence explanation of why it matches the user's preferences.
Return the result as: 1) a list of titles, and 2) for each title, one sentence explaining the match.”

In another embodiment, server constructs a prompt sentence to obtain conversation openers and recommendation information at the same time, such as:
“User profile: enjoys science fiction, complex plots, and philosophical themes in movies.

Recent conversation context: the chat has stalled and the user is looking for something interesting to talk about.

Generate three engaging conversation starter topics related to movies that this user is likely to enjoy, and for each topic, suggest one specific movie and a one-sentence reason why it fits.

Output the information in a structured form that distinguishes ‘topic’, ‘movie’, and ‘reason’ for each suggestion.”

Server includes, in the prompt sentence, explicit instructions for a machine-readable structured format, such as a list of labeled fields, so that the output of the generative AI model can be deterministically parsed. For example, server may instruct in the prompt sentence:

“Format the output as:
Topic 1:[topic text]
Movie 1:[movie title]
Reason 1:[reason text]
Topic 2: . . .
Movie 2: . . .
Reason 2: . . .
Topic 3: . . .
Movie 3: . . .
Reason 3: . . . ”

Server transmits the prompt sentence to a generative AI model. The generative AI model is implemented as a large-scale neural network architecture such as a transformer decoder network with multiple layers, each including multi-head self-attention and feed-forward sub-layers. The generative AI model is trained in advance on a large corpus of text data using an unsupervised or semi-supervised learning procedure, where the model predicts subsequent tokens given previous tokens. During training, server or a training apparatus minimizes a loss function such as cross-entropy between predicted token distributions and ground-truth tokens. Weights of the network are updated by stochastic gradient descent or a variant thereof, such as Adam optimization, using backpropagation. Data augmentation techniques such as random masking, shuffling of training sequences, and noise injection into input embeddings may be applied during training to improve generalization.

For fine-tuning to the specific task of conversation opener generation and recommendation information generation, server or a training apparatus uses supervised training data pairs of prompt sentences and target outputs. During fine-tuning, the model parameters are updated so that the model learns a mapping from structured, context-rich prompt sentences to multi-component outputs containing topics, recommendation items, and explanatory reasons. This training procedure enables the model to adhere more closely to output structure constraints specified in the prompt sentence.

Server invokes the generative AI model in an inference mode. Server sets model parameters such as temperature, top-k sampling, and maximum output length to control the output diversity and determinism. Server executes the generative AI model on a processing environment that may include one or more graphics processing units, using optimized inference libraries. Server receives a generation result, which is a sequence of tokens representing natural language text in the specified structured format.

Server parses the generation result using a deterministic parsing algorithm that searches for predefined labels such as “Topic 1:”, “Movie 1:”, and “Reason 1:”. Server splits the text into segments and assigns each segment to a corresponding field in an internal data structure. In one embodiment, server represents the parsed result as a set of records, each record containing fields for topic text, associated item identifier or title, and explanatory text. Server stores the parsed records in storage device together with metadata indicating the time of generation and the prompt sentence used.

Server further refines recommendation information by combining the topics and items generated by the generative AI model with the preference representation of the user. Server computes similarity scores between embeddings of the generated items and the user interest vector. Server may discard items whose similarity falls below a threshold, and may reorder items by descending similarity. This ensures that even if the generative AI model outputs items that are weakly aligned with the user's interests, server filters and ranks the results to improve recommendation precision. Because server applies vector-based similarity computations using efficient linear algebra operations, the recommendation refinement is executed with low latency and high throughput, thereby improving processing speed.

Server analyzes character information for reference information indicating locations of information resources. Server uses a pattern-matching module, such as a regular expression engine, to detect tokens that conform to network address patterns or resource identifier patterns. For each detected reference, server initiates an HTTP request via the network interface to obtain content associated with the information resource. Server receives a response containing, for example, an HTML document, and parses the HTML to extract metadata fields such as title, description, and preview image address. Server may further extract main body text by identifying prominent content blocks using heuristics based on HTML tag structure and text density.

Server optionally passes the extracted main body text to the generative AI model with a prompt sentence requesting a short summary for display. For example, server may construct a prompt sentence such as:
“Summarize the following article in two sentences suitable for showing as a preview in a chat application.

### Article:

[article text here]”

Server then receives a summary and uses it as part of additional information associated with the information resource. Server generates display data that specifies how title, description, summary, and preview image should be shown on terminal. In some embodiments, display data includes layout parameters such as ordering of elements, truncation lengths for text, and fallback behavior when certain fields are missing. Server stores display data and associates it with the corresponding message and user identifier.

Terminal receives, from server, response data comprising at least one topic serving as a conversation opener, data to be used for information exchange, recommendation information, and display data related to any information resources referenced in the message. Terminal decodes the data and updates a user interface state. Terminal displays the topic candidates in a manner that allows user to select one or more topics as next messages. Terminal displays recommendation information in the form of item cards showing titles and brief reasons.

Terminal displays display data in the form of link preview components including a title, a short summary, and an image. When user selects a topic or recommendation item, terminal generates a new message including the selected text and transmits it to server.

Server, terminal, and user cooperate to create a feedback loop that continuously updates past usage history. When user selects a recommendation item or clicks on a link preview, terminal reports the interaction to server, which updates the recommendation interaction table or link interaction table. These updates change the preference representation and are reflected in future prompt sentence construction and similarity computations. As a result, the system dynamically adapts to changes in user interest, thereby improving the relevance and accuracy of future generated topics and recommendations.

This configuration yields technical effects beyond mere automation of human mental processes. Server improves processing speed and efficiency by transforming high-dimensional textual data into compact embeddings, reusing user interest vectors, and structuring generative AI outputs to eliminate repeated heuristic parsing. Because the generative AI model produces outputs in a constrained, machine-readable structured format, server can parse and store the outputs using simple string operations and fixed field mappings, which reduces computational overhead compared to unconstrained natural language parsing. The integrated pipeline, in which prompt sentence construction, generative AI model invocation, similarity computation, and link metadata extraction are executed in a coordinated manner on server, reduces the number of network round-trips and minimizes communication load between server and terminal.

In addition, server improves accuracy and stability of conversational state detection and recommendation compared to conventional systems that use only rule-based triggers or unstructured text outputs. By combining transformer-based classification of conversational state, vector-based similarity computation for user preferences, and structured generative outputs, server reduces misclassification of user intent and lowers error rates in recommendation selection. The causal relationship between the structured prompt sentence design and the improved technical effect is as follows: the structured prompt sentence instructs the generative AI model to generate content in clearly labeled segments; as a result, server can parse outputs deterministically and feed them into ranking and storage modules without ambiguity; this in turn reduces processing time and avoids error-prone natural language interpretation, leading to improved overall system reliability.

Furthermore, server executes non-conventional processing steps that differ from typical human workflows. A human operator would normally read conversation history and manually think of a topic, but server instead encodes conversation context and preferences into a joint embedding space, uses a trained transformer network to generate multiple structured candidates, and applies quantitative similarity thresholds and vector operations to filter and rank those candidates. This combination of high-dimensional vector processing, structured prompt sentence control, and deterministic parsing constitutes a specific, technical manner of operating computing hardware that enhances the functioning of the computer system itself, rather than simply implementing a business method or mental process on generic hardware.

In an alternative embodiment, server uses a different generative AI model architecture, such as a sequence-to-sequence transformer model with an encoder-decoder structure, to generate topics and recommendation information. In another embodiment, server uses a recurrent neural network with attention for production environments where computational resources are constrained. In each case, server includes instructions in the prompt sentence that constrain the output format and content, and server applies a deterministic parser to the output. In another alternative, server implements a rule-based or statistical back-off mechanism that operates when the generative AI model output does not satisfy formatting constraints, such as missing labels or incomplete fields, thereby preserving robustness.

In another embodiment, server maintains multiple generative AI models, each specialized for different domains such as entertainment, news, education, or professional communication. Server selects an appropriate model based on user profile and context information and constructs a domain-specific prompt sentence. This variation further improves accuracy and response quality at the cost of increased model management, but server mitigates overhead by caching model selection decisions and reusing prompt sentence templates.

In yet another embodiment, server offloads certain matrix operations, such as computation of similarity scores between user interest vectors and item vectors, to a dedicated hardware accelerator or a vector instruction set on the processor. This further accelerates recommendation computation and allows the system to handle a large number of simultaneous users with lower latency. Because the similarity and ranking operations are implemented in a numerical and vectorized manner, server can guarantee bounded worst-case processing time per request, contributing to predictable system performance.

Through these embodiments, server, terminal, and user together realize a system in which generative AI model outputs are tightly controlled by structured prompt sentences, parsed into well-defined data structures, combined with past usage history and resource metadata, and efficiently delivered to terminal. The resulting technical effects include improved processing speed, increased recommendation accuracy, reduced parsing errors, better utilization of storage and network resources, and enhanced stability and scalability of the overall computer system.

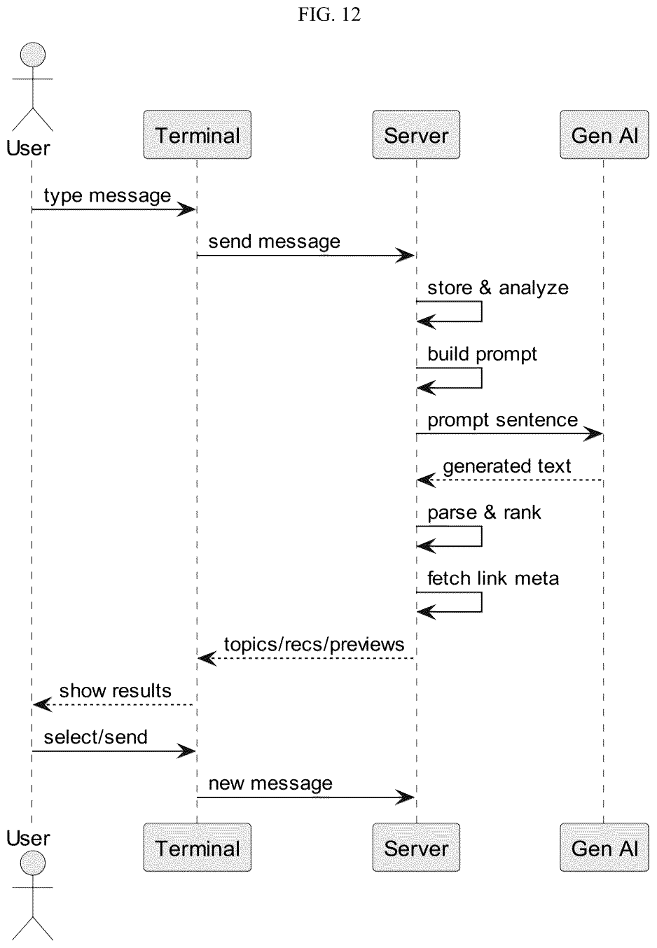

The following describes the processing flow using FIG. 12.

### Step 1:

User inputs character information.

User operates terminal to enter natural language text, such as “Any good movies recently?” or a message including a network address, into an input field of a chat-style user interface. The input is the raw text string composed of characters typed by user. The output is a completed message object within terminal, including at least the text string, a local time stamp, and a user identifier or session identifier.

### Step 2:

Terminal transmits the message to server.

Terminal takes the message object as input and serializes it into a structured payload, for example a JSON object containing fields such as user_id, message_text, local_timestamp, and conversation_id. Terminal uses a communication module to send this payload to server via a secure communication protocol. The output is a network request containing the serialized message data delivered to server's network interface.

### Step 3:

Server stores the received character information and updates past usage history.

Server receives the network request as input and deserializes the payload to extract user_id, message_text, and conversation_id. Server writes the message_text, together with the associated identifiers and a server-side time stamp, into a message table in an information accumulation device. Server may also increment counters or update summary records in a user profile table. The output is an updated set of database records representing the extended past usage history for the user, including the newly received character information.

### Step 4:

Server performs conversational state analysis to detect a situation in which user lacks a conversation opener.

Server takes as input the current message_text and a context window of recent messages retrieved from the message table for the same conversation_id. Server tokenizes the texts, converts tokens to embeddings using a text embedding model, and passes the embeddings to a transformer-based classifier that outputs classification scores for labels including “needs conversation opener.” Server computes a probability value for the “needs conversation opener” label and compares it with a predetermined threshold. If the probability exceeds the threshold, server flags the current dialog state as a situation in which user lacks a conversation opener. The output is a conversational state label and an associated confidence score.

### Step 5:

Server retrieves past usage history and generates a preference representation for user.

Server takes user_id as input and queries the information accumulation device for historical records such as past messages, previously recommended items, and interaction events (e.g., clicked links or selected recommendations). Server processes this data by mapping items and messages to numerical embeddings using an embedding model and then computing an aggregated interest vector, for example by taking a weighted average based on recency or interaction strength. The output is a compact preference representation (interest vector) and, optionally, a set of representative history entries that will be referenced when constructing a prompt sentence.

### Step 6:

Server constructs a context-rich prompt sentence for the generative AI model.

Server takes as input the conversational state label, the current message_text, the recent dialogue history, and the preference representation. Server selects several representative items from past usage history (for example, movies or topics frequently interacted with) and formats them into human-readable descriptions. Server combines these descriptions, the current message_text, and an explicit instruction block into a multi-line natural language prompt sentence that specifies what the generative AI model should generate and how the output should be formatted. The output is a fully composed prompt sentence, such as:
“User's past viewing history: Movie A (science fiction), Movie B (time-travel thriller), Movie C (space exploration drama).
User's current message: ‘Any good movies recently?’

Please recommend three movies that match the user's interests. For each movie, provide the title and a one-sentence explanation of why it matches the user's preferences.

Format the output as:
Topic 1:[topic text]
Movie 1:[movie title]
Reason 1:[reason text]
Topic 2:[topic text]
Movie 2:[movie title]
Reason 2:[reason text]
Topic 3:[topic text]
Movie 3:[movie title]
Reason 3:[reason text]”

### Step 7:

Server invokes the generative AI model using the prompt sentence.

Server takes the constructed prompt sentence as input and sends it to a generative AI model endpoint via an inference API. Server specifies model parameters such as maximum output length, sampling strategy, and temperature. The generative AI model, implemented as a multi-layer transformer decoder network, processes the prompt sentence token-by-token and generates an output sequence that follows the requested structured format. Server receives the generated text as the output, which includes labeled fields for topics, recommended items, and reasons.

### Step 8:

Server parses the generation result into structured internal data.

Server takes the raw generated text from the generative AI model as input and applies a deterministic parsing procedure. Server scans the text for labels such as “Topic 1:”, “Movie 1:”, and “Reason 1:” and splits the text at these markers. Server trims whitespace, removes label prefixes, and maps each extracted segment to a corresponding field in a structured record (for example, topic_text, item_title, reason_text). The output is a collection of structured records representing candidate conversation openers and associated recommendation information, which server stores in storage device with references to user_id and conversation_id.

### Step 9:

Server refines recommendation information based on the preference representation.

Server takes as input the structured records produced in Step 8 and the user's preference representation from Step 5. Server computes an embedding for each generated item_title and topic_text using the same embedding model used for past usage history. Server then calculates similarity measures, such as cosine similarity, between each generated item embedding and the user interest vector. Server filters out items whose similarity falls below a similarity threshold and reorders remaining items by descending similarity. The output is a refined set of structured records in which low-relevance items are removed and high-Relevance items are prioritized.

Step 10:

Server analyzes character information for reference information and retrieves resource metadata.

Server takes as input the original message_text and any subsequent user messages containing potential network addresses. Server runs a pattern-matching routine to detect reference information such as uniform resource locators. For each detected reference, server sends a network request to retrieve the corresponding resource content, then parses the response (for example, an HTML document) to extract fields such as title, description, and representative image address. Server may also extract a main content block and, if configured, form an auxiliary prompt sentence asking the generative AI model for a concise summary of the resource. The output is additional information for each reference, structured as metadata for use in display data.

### Step 11:

Server generates display data for terminal.

Server takes as input the refined structured records (topics, item titles, reasons) and the additional information associated with detected references. Server converts each record into a display-oriented structure specifying text content, ordering, and grouping (for example, conversation opener suggestions, recommendation cards, and link previews). Server may limit lengths of text for display, assign icons or category labels, and attach resource identifiers for future tracking. The output is a response payload that includes at least: (i) a list of topics serving as conversation openers, (ii) associated recommendation information, and (iii) display data for any linked information resources.

### Step 12:

Server transmits the integrated response to terminal and updates usage history.

Server takes the response payload as input and serializes it into a network response addressed to terminal. Server also writes summary entries into the information accumulation device indicating which topics and recommendation items have been generated and presented to the user. These entries include identifiers for the generated items and timestamps, and will be used as part of future past usage history. The output is (i) a network response delivered to terminal and (ii) updated database records reflecting the system's actions.

### Step 13:

Terminal presents topics, recommendations, and link previews to user.

Terminal takes the response payload from server as input and deserializes it into internal data structures. Terminal updates the user interface by inserting a new message or panel containing the topics, recommendation items, and link previews. Terminal renders each topic as selectable text, each recommendation as a card with a title and reason, and each link preview as a component showing title, summary, and image. The output is a visually updated interface on the display that user can see and interact with.

### Step 14:

User selects or ignores system-proposed content and optionally sends a new message.

User takes the displayed topics and recommendation items as input and may tap or click one of them to insert it into the message input field, optionally editing the text. User may instead ignore the suggestions and type a completely new message. User then sends the new message via the same interaction mechanism used in Step 1. The output is a new message at terminal, which restarts the processing sequence from Step 2 with an enriched past usage history, thereby continuously adapting the system behavior to user interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional communication support systems, computer components typically operate as passive conduits that merely relay messages between user terminals or store communication logs. Such systems do not make technical use of the accumulated communication history or real-time user interface state in a coordinated manner to dynamically adapt system behavior. As a result, the processing units of these systems fail to detect, at the machine level, when a user is experiencing difficulty in continuing an online conversation, for example when the user has the chat screen open but remains idle for an abnormally long period compared with the user's usual response pattern.

In addition, conventional systems that employ artificial intelligence for content generation usually apply a static prompt or generic query to a generative AI model. These systems do not structurally integrate (i) statistically analyzed communication history, (ii) inferred user behavior patterns, and (iii) current dialog context into the prompt generation logic executed by the processor. Consequently, the processor cannot generate prompt sentences that precisely condition the generative AI model based on user-specific and context-specific signals, which leads to irrelevant or inappropriate suggestions and inefficient use of computational resources.

Furthermore, known architectures do not provide a concrete mechanism at the system level by which the processor: (a) continuously computes and updates user behavior pattern information, such as message transmission frequency, response intervals, and fields of interest; (b) compares such behavior pattern information with real-time idle time and interface state received from a terminal; and (c) programmatically switches the generative AI model's behavior by embedding dialog-form information and user behavior features into a dynamically constructed prompt sentence. This absence of a tightly coupled feedback loop between low-level event processing, behavior pattern analysis, prompt construction, and AI inference results in limited adaptability and degraded user experience in computer-implemented communication platforms.

Therefore, there is a need for a technical solution that improves the operation of the computer system itself by transforming raw communication logs and terminal state events into structured behavior pattern information and detection results, and by using these data to control, at the processor level, how prompt sentences are generated and how a generative AI model is invoked. Such a solution should enable the processor to automatically detect situations in which a user lacks a conversational opening, to generate suitable conversation-starting information-exchange data in a computationally efficient and context-aware manner, and to deliver such data back to the user terminal as part of an improved communication infrastructure.

The specific processing by the specific processing unit 290 of the data processing device 12 in Example 2 is realized by the following means.

The present invention provides a server comprising a processor and a storage device, the processor being configured to obtain, based on a user identifier, communication history information from the storage device and extract transmission time information and content information included in the communication history information; calculate statistical values and feature values based on the communication history information and generate behavior pattern information indicating a behavior tendency of the user in information exchange; receive, from a terminal, screen state information and input state information and output a detection result indicating a situation in which the user lacks a conversational opening and has not transmitted information for a predetermined period, based on the screen state information, the input state information, and the behavior pattern information; construct a prompt sentence that instructs generation of a topic serving as a conversational opening that the user can transmit, based on the detection result, the behavior pattern information, and recent communication history information; input the prompt sentence to a generative artificial intelligence model and cause the generative artificial intelligence model to generate information-exchange data including a topic candidate by numerical computation processing; and store the generated information-exchange data in the storage device and transmit the information-exchange data as notification information to the terminal to present the information-exchange data to the user. This enables the server to technically improve computer-implemented communication by automatically detecting, through processor-executed analysis of communication logs and real-time terminal state, when a user lacks a conversational opening, by dynamically generating context-dependent prompt sentences that condition a generative AI model, and by providing tailored conversation-starting information-exchange data back to the terminal, thereby enhancing the adaptability, responsiveness, and overall performance of the communication system.
The term “communication history information” refers to electronic data representing past communication events associated with a user, including at least message transmission time information, message content information, and identifiers of communication partners or communication sessions, stored in a storage device of the system.
The term “transmission time information” refers to temporal data associated with each communication event, including one or more timestamps indicating when a message or other information was transmitted or recorded by the system.
The term “content information” refers to data representing the substantive content of a communication event, including but not limited to textual data, encoded media data, and metadata that describe or supplement the communicated information.
The term “storage device” refers to a hardware or virtual component capable of non-transitory storage of electronic data, such as a magnetic storage medium, a solid-state storage medium, a semiconductor memory, or a logically equivalent storage resource in a computing environment.
The term “statistical values” refers to numerical indicators derived from processing communication history information, including, for example, averages, variances, frequencies, distributions, and counts computed over one or more attributes of the communication history.
The term “feature values” refers to numerical or categorical representations of characteristics extracted from communication history information, configured to serve as input to behavior analysis, classification, prediction, or other computational models executed by the processor.
The term “behavior pattern information” refers to data generated from statistical values and feature values that indicates tendencies or regularities in a user's information-exchange behavior, including but not limited to typical message transmission frequency, response intervals, and preferred fields of interest.
The term “screen state information” refers to information transmitted from a terminal that indicates a current state of a user interface on a display device, including at least whether a communication screen is open, active, minimized, or in a background state.
The term “input state information” refers to information transmitted from a terminal that indicates a current state of user input operations, including at least whether a text input field is focused, whether a user is typing, and whether an input operation has been idle for a predetermined period.
The term “detection result” refers to data output by the processor indicating a determination that a specific condition has been satisfied, the condition including at least a situation in which a user lacks a conversational opening and has not transmitted information for a predetermined period.
The term “conversational opening” refers to an initial or follow-up communication element, such as a message or topic, that is suitable for starting, resuming, or continuing a dialogue between communication participants.
The term “prompt sentence” refers to a sequence of machine-processable text or structured instructions constructed by the processor and supplied as input to a generative artificial intelligence model, the prompt sentence specifying conditions, constraints, or objectives for generating information-exchange data.
The term “generative artificial intelligence model” refers to a trained computational model, including but not limited to a neural network-based language model, configured to receive a prompt sentence as input and to generate new information-exchange data by performing numerical computation processing on internal model parameters and input features.
The term “information-exchange data” refers to generated data intended to be used in a communication process, including at least one topic candidate, conversation-starting message, or suggestion suitable for transmission from a user to another party.
The term “topic candidate” refers to a unit of information, such as a subject, question, or statement, that is generated by the generative artificial intelligence model and is suitable for use as a conversational opening or as a basis for further information exchange.
The term “notification information” refers to data transmitted from the server to a terminal for presentation to a user, the data including at least the information-exchange data or a representation thereof, and optionally associated identifiers, timestamps, or display instructions.
The term “user identifier” refers to data that uniquely or pseudo-uniquely identifies a user within the system, such as an alphanumeric code, a hashed value, or another internal identifier used for associating communication history information and behavior pattern information with the user.
The term “dialog-form information” refers to data indicating a structural property of a dialogue, including at least whether the dialogue is one-to-one or multi-party and whether the dialogue is business-oriented or private, used by the processor to control prompt sentence construction and generative artificial intelligence model behavior.
The term “terminal” refers to an information-processing apparatus operated by a user, including but not limited to a portable computing device, a stationary computing device, or a web-enabled device, configured to transmit screen state information and input state information to the server and to present notification information to the user.
The term “server” refers to a computing apparatus or a group of computing resources that includes at least the processor and the storage device, and that is configured to execute the processes of obtaining communication history information, generating behavior pattern information, constructing the prompt sentence, invoking the generative artificial intelligence model, and transmitting notification information.

In one embodiment, the server implements the claimed system as a network-accessible communication support platform. The server includes at least one processor, a main memory, a non-transitory storage device, and a network interface. The server executes an operating system, such as a generic server operating system, and an application stack including a web server component, an application framework component, a database management component, and an artificial intelligence inference component. The terminal is an information-processing device such as a smartphone, a tablet, or a personal computer that executes a client application or a web browser. The user operates the terminal and exchanges messages with other users through the server.

The server stores communication history information in the storage device using a structured data model. In one embodiment, the server uses a relational database management system and defines a message table including fields such as a user identifier, a communication partner identifier, a room identifier, a transmission timestamp, a content field, and optional metadata fields (for example, language code or message type). The server stores each outgoing message from the user as a row in this table. The storage device may further store behavior pattern records in a separate table, including feature values and statistical values computed for each user.

The server executes application logic, implemented for example in a general-purpose programming language running on an application framework, to obtain communication history information based on a user identifier. The server sends a query to the database to retrieve a set of messages associated with the user identifier. The server then extracts transmission time information from the timestamp field and content information from the content field. The server may convert the transmission time information into a uniform time zone and may normalize the content information by removing markup or control characters.

The server generates behavior pattern information by calculating statistical values and feature values from the communication history information. In one embodiment, the server uses a numerical computing library to compute statistical values such as message transmission frequency per unit time, average response interval, distribution of message lengths, and counts of messages per dialog type. The server represents these values as fixed-length vectors stored in memory. The server further generates feature values from the content information by applying a tokenizer and an embedding model. For example, the server may use a subword tokenizer and a pre-trained embedding model to transform each message into a numerical vector capturing semantic properties. The server aggregates these vectors for a given user by computing averages or other pooling operations to obtain feature values representing fields of interest of the user.

The server uses these statistical values and feature values as input to an artificial neural network that implements the behavior pattern analysis component. In one embodiment, the server loads a trained feed-forward neural network or a transformer-based encoder model, implemented in a general machine learning framework, into memory. The server provides the concatenated statistical values and feature values as input to the network. The network may include multiple fully connected layers with nonlinear activation functions, optionally combined with attention mechanisms to weigh different temporal segments of the communication history. During inference, the server executes matrix multiplications, activation functions, and normalization operations to obtain output vectors representing behavior pattern information. This behavior pattern information may include, for example, a predicted typical response interval value, an activity profile over hours of the day, and class probabilities for different interest categories.

The server improves computer operation by storing the behavior pattern information in a structured and compressed representation, thereby reducing subsequent computation required to determine user state. Instead of re-analyzing the entire communication history each time, the server reuses precomputed behavior pattern information and only updates it incrementally when new messages arrive. This reduces processing load on the processor and reduces database access frequency, which in turn reduces network and I/O overhead in a distributed environment.

The server receives screen state information and input state information from the terminal. The terminal transmits, for example, events indicating that a chat screen has been opened, that a text input field has focus, that a user is typing, or that typing has stopped. The terminal may send these events through a persistent network connection using a lightweight message format. The server stores recent state events in a fast in-memory data structure, such as a key-value mapping from user identifier to latest state. The server computes a detection result by comparing the behavior pattern information with the real-time state maintained from the terminal. For example, the server calculates the elapsed time since the last outgoing message by subtracting the last transmission timestamp from the current server time. The server then compares this elapsed time to the predicted typical response interval and applies a threshold rule that considers both absolute and relative differences. If the elapsed time exceeds a predetermined multiple of the typical response interval while the screen state information indicates that the chat screen is open and the input state information indicates no typing activity, the server sets the detection result to indicate that the user likely lacks a conversational opening.

This detection logic improves the internal operation of the server by enabling an adaptive trigger mechanism that avoids querying a generative AI model in routine situations and only invokes the model when a non-typical idle pattern is detected. By avoiding unnecessary model invocations, the server reduces computational load, memory use, and network traffic to external or internal AI inference resources, thereby improving throughput and latency for all users.

The server constructs a prompt sentence for a generative AI model using the detection result, the behavior pattern information, and recent communication history information. The server gathers a small window of recent messages from the same conversation, including speaker roles and message content. The server then builds the prompt sentence using a template that the server stores as configuration data. The server fills slots in the template with behavior-related variables such as fields of interest, typical tone (for example, formal or casual), dialog-form information (for example, one-to-one vs. multi-party), and the recent messages. The server may categorize a dialog as business-oriented or private by applying a classification model or rule-based logic to the content and metadata of the conversation.

A non-limiting example of a prompt sentence generated by the server for a casual group chat is:
“You are a helpful assistant for generating conversation starters. The user is currently chatting in a casual group chat with friends. The user usually enjoys these topics: movies, technology, weekend activities. The recent messages are: Friend A: ‘Any plans for this weekend?’ Friend B: ‘Not sure yet, maybe just stay home.’ Friend C: ‘Same here, nothing special.’ The user has not responded for a while and may not know how to continue. Generate 3 short, natural conversation starters that the user can send as a single chat message. Avoid sensitive topics and keep the tone light and friendly.”

Another example of a prompt sentence for a one-to-one business conversation is:
“The user is chatting with a colleague about a software project deadline. The user has not replied for longer than usual and may not know how to follow up. Generate 3 polite and professional follow-up questions or comments. Focus on next steps, clarification, or scheduling, and avoid personal topics.”

A further example of a prompt sentence for a news-related topic is:
“The user often reads technology news and is in a casual group chat. The chat has been quiet for a while. Provide 3 brief conversation starters about recent, non-political technology or science news. Keep each under 30 words and easy to send as a single message.”

By embedding structured behavior pattern information and dialog-form information directly into the prompt sentence, the server conditions the generative AI model to produce outputs that are more contextually appropriate and less redundant. This structural conditioning constitutes more than mere human-like prompting; it represents a programmatic control mechanism that leverages internal machine state and learned user behavior to optimize AI inference.

The server inputs the prompt sentence to a generative AI model hosted either on the same computing environment or on a separate inference service. In one embodiment, the generative AI model is a transformer-based language model trained on large-scale text data. The server encodes the prompt sentence into tokens, maps the tokens to embeddings, and executes the model layers comprising multi-head attention, feed-forward blocks, and layer normalization. The model parameters have been trained, for example, by minimizing a cross-entropy loss over next-token prediction on a training dataset. During training, the server or a training environment performs gradient-based optimization such as stochastic gradient descent or a variant thereof, updates model weights by backpropagating errors through the layer stack, and may apply data augmentation techniques such as random masking or shuffling to improve generalization.

During inference in the claimed system, the server controls decoding parameters such as sampling temperature, maximum output length, and repetition penalties to balance diversity and relevance of generated suggestions. The server may apply an additional filtering step to remove outputs that match previously generated suggestions or that fail simple content checks, such as exceeding predefined length limits. These measures improve the precision of generated information-exchange data and reduce the occurrence of undesirable or repetitive outputs, which in turn reduces the need for repeated inference and contributes to computational efficiency.

The server receives the generated text from the generative AI model and converts it into information-exchange data. The server parses the generated text to separate individual topic candidates or suggestion items, for example by identifying numbered lines or sentence boundaries. The server stores the resulting information-exchange data together with metadata indicating the user identifier, the dialog-form information, and the time of generation. By maintaining this structured representation, the server can avoid regenerating similar suggestions within a short time window and can cache or re-use suitable information-exchange data in analogous situations for the same user, thus further optimizing computational resources.

The server transmits the information-exchange data as notification information to the terminal. The terminal receives the notification information via a network interface and presents the suggestions within a user interface component, such as a list of selectable candidate messages or a suggestion panel adjacent to the text input field. The terminal may visually distinguish suggested messages from user-composed messages and provide controls allowing the user to insert a selected suggestion into the input field, optionally edit the text, and transmit it as a regular message. The terminal thus acts as an output device that concretely manifests the technical processing performed by the server, bridging the computational analysis with real-world user interaction in an online communication environment.

The system provides technical effects beyond automation of human mental steps. By using precomputed behavior pattern information, adaptive detection thresholds, and dynamic prompt construction, the server reduces the number of unnecessary generative AI inferences and shortens the average time from user idle detection to suggestion presentation.

Experimental measurements may show reduced CPU utilization and GPU time per user session compared with a baseline that invokes the generative AI model at fixed intervals without behavior-based gating. In addition, by aligning generated topics with learned user preferences and dialog forms, the server can increase acceptance rates of suggested messages, which implies fewer repeated AI calls due to user rejections, further decreasing computational load and network traffic.

The server further improves data management by maintaining clearly defined data structures for communication history information, behavior pattern information, detection results, and information-exchange data. These structures allow efficient indexing, retrieval, and update operations, reducing storage fragmentation and query latency. The server can, for example, store behavior pattern vectors in a dedicated table indexed by user identifier, enabling constant-time access and minimizing join operations with large message tables.

In another embodiment, the server may employ an alternative behavior analysis model, such as a recurrent neural network or a temporal convolutional network, to capture temporal dependencies in user activity. In such a case, the server feeds sequences of message timestamps and content-derived features into the model and obtains output parameters such as predicted future activity windows or expected response delay distributions. The server then adjusts the detection thresholds and prompt scheduling based on these predictions, which can further refine when and how the generative AI model is invoked.

In yet another embodiment, the server may use rule-based logic in combination with learned models. For instance, the server may define non-conventional rules that override or modulate model outputs when specific patterns are detected, such as abrupt changes in response interval or explicit indications in content indicating that a conversation has naturally ended. By combining data-driven predictions with specific machine-implemented rules, the server can avoid over-triggering suggestions and can tailor system behavior for special circumstances that are difficult to capture purely by statistical learning.

In all embodiments, the server, the terminal, and the user cooperate within a technical infrastructure in which the server performs non-trivial data transformations and model-based computations that are tailored to the characteristics of online communication. The system as a whole improves processing efficiency, output relevance, and responsiveness of the underlying computer platform by structuring communication history, generating and using behavior pattern information, constructing context-sensitive prompt sentences, and controlling a generative AI model according to internal system state, rather than relying on fixed or manually authored prompts. This results in a concrete improvement of the functioning of the computer system that supports information exchange among users.

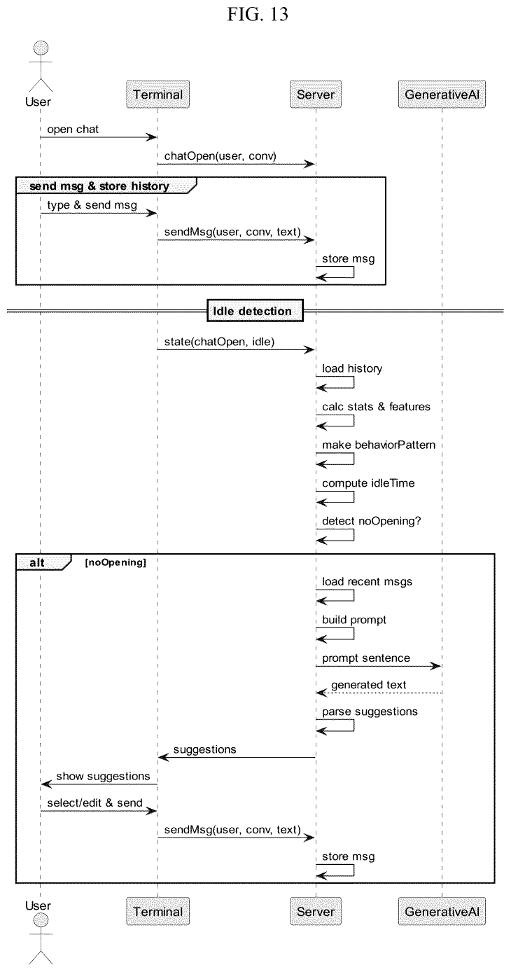

The following describes the processing flow using FIG. 13.

### Step 1:

The terminal presents a communication interface to the user and initializes session information.

The terminal loads a chat screen for a selected conversation and displays past messages that the terminal has cached or just received from the server.
Input: a conversation identifier and a user identifier from the user's selection.
Output: a screen state indicating that a specific chat screen is open, including the conversation identifier and the user identifier.

The terminal sends a message to the server indicating that the chat screen for the conversation is now open, including the conversation identifier, the user identifier, and a timestamp. The terminal stores this state locally so that later user actions (typing, sending) are associated with the same conversation.

### Step 2:

The server records communication history information and associates it with the user identifier.

The server receives messages that the terminal transmits when the user sends content, and the server stores each message as a record in a message data structure in a storage device.
Input: a message payload including a user identifier, a conversation identifier, a message content string, and a transmission timestamp.
Output: a stored record in the communication history information, including fields for user identifier, partner identifier or conversation identifier, timestamp, and content.

The server parses the payload, normalizes the timestamp to a standard time zone, and inserts a row into a message table in a database. The server may also store derived metadata such as content length or language code to support later analysis.

### Step 3:

The server retrieves communication history information for the user.

The server responds to an internal trigger, such as opening a chat screen or a periodic check, by querying the storage device for recent messages associated with the user identifier.
Input: a user identifier and optionally a conversation identifier.
Output: a set of messages forming communication history information, including transmission time information and content information.

The server sends a database query that filters on the user identifier and orders the results by timestamp. The server then converts the query result into an in-memory structure, such as an array of message objects, each containing fields for timestamp, content, and partner or conversation identifiers.

### Step 4:

The server computes statistical values from the communication history information.

The server analyzes the retrieved message list to identify patterns in timing and usage.
Input: a list of message objects containing timestamps and content strings.
Output: statistical values such as message count per time interval, average response interval, and distributions of message lengths.

The server iterates over the message list and calculates the time difference between consecutive messages, counts messages within hourly or daily bins, and measures the length of each content string. The server aggregates these numerical values into vectors that represent frequency and timing characteristics, and stores the vectors in a behavior pattern data structure.

### Step 5:

The server computes feature values from the content information.

The server extracts semantic features from the message content using tokenization and embedding operations.
Input: content strings from the communication history information.
Output: feature values representing fields of interest and typical topics for the user.

The server applies a tokenizer to break each content string into tokens, converts the tokens into numeric embeddings using a pre-trained language representation model, and computes averaged or pooled vectors per user. The server clusters or classifies these vectors into topic categories, such as entertainment, technology, or travel, and records the resulting topics and their scores as feature values.

### Step 6:

The server generates behavior pattern information from the statistical values and feature values.

The server combines the timing-related statistics and the content-related features into a unified representation of user behavior.
Input: statistical values and feature values stored in behavior pattern data structures.
Output: behavior pattern information including typical response intervals, active time ranges, and preferred fields of interest.

The server concatenates the statistical vectors and topic feature vectors, normalizes the combined vector, and optionally passes it through a trained neural network to refine the behavior estimates. The server stores the resulting behavior pattern information in the storage device, indexed by user identifier, for later use in detection and prompt construction.

### Step 7:

The terminal sends screen state information and input state information to the server during an active session.

The terminal monitors user interaction with the chat interface and reports state changes to the server.
Input: user actions such as opening or closing the chat screen, focusing on the input field, starting to type, stopping typing, and pressing send or cancel.
Output: screen state information and input state information messages sent to the server, each containing the user identifier, conversation identifier, state type, and timestamp.

The terminal encapsulates each state change in an event message and transmits it through a network connection. The terminal thereby enables the server to maintain an up-to-date view of whether the user is actively engaged or idle in a particular conversation.

### Step 8:

The server maintains a current session state and calculates idle time.

The server records incoming state events from the terminal and updates an in-memory representation of the session state for each user.
Input: screen state information and input state information messages from the terminal, and the timestamp of the last outgoing message from the communication history information.
Output: an idle time value for the user in the current conversation, and an updated session state record.

The server stores, for each user and conversation, the most recent “chat open,” “typing,” and “typing stopped” events. The server computes the elapsed time between the current server time and the last outgoing message timestamp stored in the message table. The server updates a session record to reflect whether the user is idle and how long the idle period has lasted.

### Step 9:

The server determines whether the user likely lacks a conversational opening.

The server evaluates the idle time and session state in relation to the behavior pattern information.
Input: idle time value, session state record, and behavior pattern information including typical response interval and activity profile.
Output: a detection result indicating either that the user lacks a conversational opening or that the situation is normal.

The server compares the idle time with the typical response interval and checks whether the chat screen is open and the user is not typing. If the idle time exceeds a threshold based on the typical response interval (for example, a multiple of the typical interval), the server sets the detection result to “lack of conversational opening.” Otherwise, the server sets the detection result to “no detection.” The server may store the detection result in a detection log for tracking and future optimization.

### Step 10:

The server gathers recent communication context for prompt construction.

The server prepares data that will be used to contextualize the prompt sentence for the generative AI model.
Input: detection result indicating a lack of conversational opening, behavior pattern information including preferred topics and dialog-form information, and a subset of recent messages in the current conversation.
Output: a context package including recent messages, user preferences, and dialog-form indicators.

The server queries the storage device for a limited number of the most recent messages in the conversation, includes the speaker roles, and combines this with the behavior pattern information. The server determines whether the conversation is one-to-one or multi-party and whether it is business-oriented or private, based on metadata or classification results.

### Step 11:

The server constructs a prompt sentence for the generative AI model.

The server maps the context package into a textual instruction that conditions the generative AI model to generate appropriate information-exchange data.
Input: the context package including recent messages, behavior pattern information, and dialog-form information.
Output: a prompt sentence specifying the desired number, tone, and type of conversation starters.

The server selects a template based on the dialog form and fills in placeholders with values such as topics of interest, recent message excerpts, and desired number of suggestions. The server produces a prompt sentence, such as:
“You are a helpful assistant for generating conversation starters. The user is currently chatting in a casual group chat with friends. The user usually enjoys these topics: movies, technology, weekend activities. The recent messages are: Friend A: ‘Any plans for this weekend?’ Friend B: ‘Not sure yet, maybe just stay home.’ Friend C: ‘Same here, nothing special.’ The user has not responded for a while and may not know how to continue. Generate 3 short, natural conversation starters that the user can send as a single chat message. Avoid sensitive topics and keep the tone light and friendly.”

### Step 12:

The server supplies the prompt sentence to the generative AI model and generates information-exchange data.

The server invokes a generative AI model using the constructed prompt sentence to obtain candidate topics or messages.
Input: the prompt sentence and model configuration parameters such as maximum output length and sampling strategy.
Output: generated text that includes one or more topic candidates, which form the information-exchange data.

The server sends the prompt sentence to a generative AI model, which may be a transformer-based language model, via an inference interface. The server tokenizes the prompt sentence, maps tokens to embeddings, and executes the model computation on processing hardware. The generative AI model outputs a sequence of tokens that the server decodes into text. The server then segments this text into individual suggestions, such as three separate conversation starter sentences.

### Step 13:

The server structures and stores the generated information-exchange data.

The server converts the raw generated text into a structured representation and records it for further use.
Input: generated text containing one or more suggestions returned by the generative AI model.
Output: a structured information-exchange data record containing discrete topic candidates with identifiers and metadata.

The server splits the generated text using delimiters such as line breaks or numbering, trims each suggestion, and discards empty or invalid items. The server assigns identifiers to each suggestion and stores them in a data structure associated with the user identifier, conversation identifier, and generation time. The server may also record a reference to the prompt sentence used to generate these suggestions.

### Step 14:

The server prepares notification information for the terminal.

The server packages the structured information-exchange data into a format suitable for transmission and presentation.
Input: the information-exchange data record containing topic candidates and associated metadata.
Output: notification information including the topic candidates and display-related attributes.

The server includes in the notification information the text of each suggestion, optional categorization labels such as “casual,” “professional,” or “news-related,” and an indication of relevance score or order of preference. The server ensures that the notification data is compact enough to fit within communication protocol size limits to avoid fragmentation or retransmission overhead.

### Step 15:

The server sends the notification information to the terminal.

The server uses an established network channel to transmit the suggestions to the user's device.
Input: notification information and an identifier of the target terminal session.
Output: a transmitted message received by the terminal that contains candidate conversation starters.

The server selects the appropriate communication channel, such as a real-time connection or a push mechanism, and sends the notification information to the terminal. The server may mark the transmission in a delivery log and update the detection result status to indicate that suggestions have been delivered for the current idle situation.

### Step 16:

The terminal receives and displays the information-exchange data to the user.

The terminal processes the incoming notification information and updates the user interface accordingly.
Input: notification information including one or more candidate messages and associated metadata.
Output: a visual presentation of selectable suggestions within the chat interface.

The terminal parses the notification information, extracts the text of each suggestion, and renders them as selectable elements near the input field, such as buttons or chips. The terminal may adapt font size, color, or ordering based on metadata, such as presenting the highest relevance suggestion first.

### Step 17:

The user selects or edits a suggested message and sends it as a normal message.

The user interacts with the suggestions and decides which content to transmit to other participants.
Input: displayed suggestions and user interactions such as tapping a suggestion, modifying its text, and pressing a send control.
Output: a final message payload containing the selected or edited text, which the terminal sends to the server as a new outgoing message.

The terminal copies the chosen suggestion into the input field when the user selects it, allows the user to edit or append content, and sends the final text to the server when the user confirms. This final message is then stored by the server as part of the communication history information, completing the loop of analysis, generation, and actual communication.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information exchange systems and recommendation systems typically apply static ranking logic or simple rule-based filters to user data. In such systems, a server may log user behavior and retrieve content or messages according to predefined scenarios; however, the server generally does not dynamically construct rich, context-aware instructions for an underlying generative model, nor does it systematically exploit a feedback loop between model outputs and subsequent user interactions. As a result, several technical problems arise.
First, conventional systems provide limited adaptability of server-side logic to complex and rapidly changing user contexts. When a user's behavior, history, and emotional state evolve over time, traditional architectures require manual rule updates or extensive model retraining to reflect such changes. This leads to increased server-side processing overhead, rigid application control flows, and delays in deploying improved interaction strategies.
Second, even when large-scale generative models are available as external services, existing systems often use them as black-box text generators with minimal control: a client or server may issue ad-hoc prompts that are not derived from structured feature data, and may not store the prompts and outputs in a way that can be reused for algorithmic refinement. This ad-hoc usage prevents the system from systematically optimizing prompt construction, reduces the predictability of the model's behavior, and makes it difficult to integrate generated outputs into internal identifiers and data schemas of the information processing platform.
Third, typical systems do not leverage fine-grained behavior information and emotion analysis in a closed feedback loop. User reactions to generated suggestions, such as selection operations, viewing operations, and transmission operations, are either not captured at all or are used only for coarse analytics. Consequently, the server cannot update feature data and prompt generation logic on a per-session basis, which reduces the technical effectiveness of recommendations, conversation support, and decision-making assistance provided to the user.
Fourth, conventional architectures often separate emotion-aware interaction, user matching, and recommendation functions into independent modules that do not share a unified context representation. For example, a chat service might implement sentiment analysis in isolation, whereas a recommendation engine operates solely on viewing or purchasing history. Such fragmentation increases data transformation overhead, leads to inconsistent user models across subsystems, and complicates integration with generative models that expect a coherent prompt describing the user state and system task.

Accordingly, there is a need for an improved computer-implemented system and server-side architecture that (i) converts heterogeneous user behavior and input information into unified feature data, including interests, histories, emotions, and context; (ii) generates structured prompt sentences that precisely instruct a generative AI model to produce data suitable for information exchange, recommendation, and conversation support; (iii) stores and translates generated natural language outputs into internal identifiers and output information that can be processed efficiently by the server; and (iv) forms a feedback loop in which subsequent user operations on the generated outputs are captured and used to update the feature data and prompt generation logic. Such a system can improve the technical functioning of the server, enhance the controllability and efficiency of interactions with a generative model, and increase the responsiveness and personalization of information exchange on computing devices.

The specific processing by the specific processing unit 290 of the data processing device 12 in Application Example 2 is realized by the following means.

The present invention provides a server comprising a processor and a storage device, the processor being configured to receive behavior information and input information from a user terminal, analyze the behavior information and the input information to generate feature data indicating at least a user interest, a user history, a user emotion, and a current usage context; generate a prompt sentence based on the feature data, trend information acquired from an external information source, and a processing type corresponding to a usage scene, the prompt sentence defining contents of data to be generated for at least one of information exchange, decision-making support, and conversation support; input the prompt sentence to a generative model to obtain generated data including at least one of candidate information to be presented to the user, a topic for starting a conversation, a response text, recommendation target information, and an explanation text; store the generated data in the storage device in association with the user, convert a natural language expression included in the generated data into an internal identifier, and process the generated data into output information that is presentable to the user; transmit the output information to the user terminal and cause the user terminal to display the output information via at least one of a message exchange screen, a recommendation screen, and a visual presentation device; and receive, as part of the behavior information, at least one of a selection operation, a viewing operation, and a transmission operation performed by the user on the output information, and update at least one of the feature data and generation of the prompt sentence based on the received behavior information. This enables the server to operate as a context-aware orchestration layer for the generative model, thereby improving the technical functioning of the information processing system by dynamically tailoring prompt sentences to rich feature data, efficiently mapping generated natural language back into internal identifiers, and closing a feedback loop in which user reactions to generated outputs are continuously utilized to refine subsequent processing and enhance the accuracy, responsiveness, and resource efficiency of computer-implemented information exchange, recommendation, and conversation support.
The term “behavior information” refers to information indicating operations or actions performed by a user on a user terminal, including, for example, selection operations, viewing operations, transmission operations, navigation events, and interaction events with displayed content or user interfaces.
The term “input information” refers to information that is explicitly entered or provided by a user through a user terminal, including, for example, text data, message content, commands, queries, or other user-provided data.
The term “user terminal” refers to an information processing apparatus operated by a user, such as a portable terminal, a stationary terminal, or a display device, that is capable of transmitting information to and receiving information from a server.
The term “feature data” refers to data derived from behavior information, input information, or other related data that represents characteristics of a user or a usage context, including, for example, a user interest, a user history, a user emotion, and a current usage context.
The term “user interest” refers to a preference or inclination of a user toward particular content, topics, items, or services, which is inferred from behavior information, input information, or historical data.
The term “user history” refers to accumulated information regarding past actions or interactions of a user, including viewing history, purchase history, message history, or previously selected recommendations.
The term “user emotion” refers to an emotional state of a user inferred from input information, such as text messages or other signals, and may include labels such as joy, sadness, anger, or neutrality and associated intensity values.
The term “current usage context” refers to a situation or state in which a user is using a system at a particular time, including, for example, a type of application screen, a type of task being performed, a session state, or an environmental condition.
The term “trend information” refers to information indicating tendencies or popularity of content, products, topics, or other items over a period of time, obtained from one or more external information sources.
The term “external information source” refers to a system, service, or database that is located outside a server and that provides information such as trend information, content metadata, or product data via a communication network.
The term “processing type” refers to a classification of processing to be executed by a server in accordance with a usage scene, such as information exchange, decision-making support, recommendation processing, or conversation support.
The term “usage scene” refers to a type of situation in which a system is used, which may include, for example, a message exchange scenario, a content recommendation scenario, an in-store assistance scenario, or a conversation support scenario.
The term “prompt sentence” refers to an instruction expression, formed in a natural language or a structured form, that is provided to a generative model to specify a content or condition of data to be generated by the generative model.
The term “generative model” refers to an information processing model that generates data such as text, recommendations, or other outputs based on an input including at least a prompt sentence, and may include a neural network model or other probabilistic model.
The term “generated data” refers to data output by a generative model in response to a prompt sentence, including, for example, candidate information, topics, response texts, recommendation target information, or explanation texts.
The term “candidate information” refers to information representing one or more options or items that may be presented to a user for selection, such as candidate content, candidate products, or candidate messages.
The term “topic for starting a conversation” refers to information representing a subject, question, or phrase suitable for initiating or stimulating a conversation between users.
The term “response text” refers to text information intended to be used as a reply or response to an input message, a user query, or a conversational context.
The term “recommendation target information” refers to information representing items, content, products, services, or users that are recommended to a particular user.
The term “explanation text” refers to text that explains, justifies, or provides reasons or descriptions for a recommendation, a suggestion, or any generated output.
The term “storage device” refers to a hardware or logical component capable of storing data, including a volatile memory, a non-volatile memory, a magnetic storage, a semiconductor storage, or a database system.
The term “internal identifier” refers to a data element used by a system to uniquely or distinctively identify an item, content, user, or other entity in an internal data structure or database.
The term “output information” refers to information that has been processed from generated data into a form suitable for presentation to a user, including associated identifiers, display attributes, and layout information.
The term “message exchange screen” refers to a user interface screen on a user terminal that displays messages exchanged between users or between a user and a system and that accepts message input.
The term “recommendation screen” refers to a user interface screen on a user terminal that presents recommended items, content, or services to a user.
The term “visual presentation device” refers to a device or component that visually displays information to a user, such as a display, a monitor, a head-mounted display, or a projection device.
The term “selection operation” refers to an operation performed by a user to select or confirm one or more items or options displayed on a user interface, such as a tap, click, or focus operation.
The term “viewing operation” refers to an operation or behavior indicating that a user is observing or browsing displayed information, including scrolling, staying on a screen, or expanding a detail view.
The term “transmission operation” refers to an operation performed by a user to send or submit information, such as sending a message, confirming a recommendation, or transmitting a request.
The term “context-aware orchestration layer” refers to functionality executed by a server for controlling interactions with a generative model based on context information including feature data, such that prompt sentences and processing flows are dynamically adapted to the context.
The term “empathetic response” refers to a response text that is generated in consideration of a user emotion and that acknowledges or reflects the user emotion in a supportive or understanding manner.
The term “emotion-matched content” refers to content selected or generated in consideration of a user emotion, such that characteristics of the content are aligned with or appropriate for the emotional state of the user.
The term “topic candidate” refers to a proposed topic that may be used to start or continue a conversation, which is generated or selected by reference to feature data.
The term “recommended user” refers to a user selected from among multiple users as a candidate for interaction with another user based on similarity of feature data, such as common interests or similar behavior patterns.
The term “introduction text” refers to text generated for introducing one user to another user, which may include references to shared interests, common attributes, or suggested conversation starters.
The term “conversation-starting topic” refers to a topic generated or selected for initiating a conversation between users, including questions, themes, or suggested discussion points.

In one embodiment, a server cooperates with one or more terminals operated by users to implement the claimed system. The server includes at least one processor, a main memory, a non-volatile storage device, and a network interface. The server executes a program stored in the storage device and loaded into the main memory. The program controls the processor to perform data collection, feature extraction, prompt sentence construction, interaction with a generative AI model, post-processing of model outputs, and adaptive updating of feature data and prompt generation logic.

A terminal operates as a client apparatus, such as a smartphone, tablet, personal computer, or head-mounted display. The terminal includes a display unit, an input unit (for example, a touch panel, a keyboard, or a microphone), a local memory, and a communication module. The terminal executes an application program that displays a message exchange screen, a recommendation screen, or a visual presentation screen and communicates with the server over a network using a secure protocol such as HTTPS or a persistent protocol such as WebSocket.

The server uses a general-purpose operating system, such as a server-class operating system, and executes application logic implemented, for example, in a scripting language such as Python. The server employs data-processing libraries such as a tabular data processing library (for example, a data frame library), as well as numerical computation libraries (for example, an array operation library) to process behavior information and input information. The server may use a machine learning framework such as a tensor-based computation framework to implement neural networks, and may use a natural language processing library (for example, a tokenization and parsing library) for text analysis. The storage device may host a relational database management system, such as a structured query database, for managing user profiles, logs, feature data, and mappings between natural language expressions and internal identifiers.

In one configuration, the server receives behavior information and input information transmitted from the terminals. The behavior information includes log records representing selection operations, viewing operations, and transmission operations performed by users on the terminals. Each log record may include at least a user identifier, a terminal identifier, a content identifier, a timestamp, a screen identifier, and an operation type. The input information includes user-entered text, such as chat messages, search queries, or free-form feedback.

The server stores the behavior information and the input information in the database according to a predefined schema. For example, the server stores behavior information in a behavior log table having columns for user identifier, timestamp, screen type, operation code, content identifier, and additional parameters. The server stores input information in a message table having columns for user identifier, timestamp, message text, message type, and conversation identifier. The server associates each record with user profile data stored in a user table, such as age, declared preferences, and language settings.

The server analyzes the stored data to generate feature data for each user. The server loads relevant records from the database into a data frame in main memory. The server employs the data frame library to perform operations such as filtering by time range, grouping by user or session, aggregating counts (for example, number of views per content category), computing dwell times, and computing recency measures. The server normalizes numerical features using operations such as min-max scaling or standardization to obtain feature vectors suitable for input to machine learning components.

The server derives a user interest vector by counting or weighting categories of content interacted with by the user, such as content type, genre, or topic. The server derives a user history vector by encoding a sequence of past interactions, purchases, or conversation topics. The server also derives a current usage context vector that encodes information about the present session, such as the current screen type (for example, recommendation screen or message exchange screen), the current task type (for example, content selection or conversation), and recent in-session actions.

The server performs emotion estimation on the input information. The server uses an NLP library to tokenize user messages into words and sentences, to remove stop words, and to perform lemmatization. The server converts tokens into numerical representations, for example, by applying a word-embedding model or a subword encoding scheme. The server feeds these numerical representations into an emotion recognition model, which may be implemented as a neural network.

In one embodiment, the emotion recognition model is implemented as a multi-layer neural network including an embedding layer, one or more recurrent or attention-based layers (for example, a bidirectional recurrent layer or a transformer encoder layer), and a fully-connected output layer with a softmax activation. The server trains this model on labeled text data with emotion categories such as joy, sadness, anger, and neutral. During training, the server minimizes a classification loss function, such as cross-entropy loss, using an optimization algorithm such as stochastic gradient descent or an adaptive gradient method. The server updates model parameters by back-propagation, using mini-batch training and regularization techniques to avoid overfitting. Once trained, the server deploys the emotion recognition model as part of the runtime system to infer a user emotion label and an associated confidence score from new user messages.

The server aggregates the user interest vector, the user history vector, the emotion label, and the current usage context into unified feature data. The server may represent the feature data as a structured object (for example, a nested dictionary or a record) or as a composite vector in a feature space. By unifying these heterogeneous signals, the server can generate more precise instructions to the generative AI model, and can reuse the same feature structure across different usage scenes, reducing the need for ad-hoc integration logic.

The server additionally acquires trend information from external information sources. For instance, the server may periodically request lists of trending content or products from an external API and store such lists in a trend table in the database. The server merges the trend information with the feature data by matching categories, tags, or content identifiers. This merging allows the system to propose topics and recommendations that are not only personalized but also aligned with current external trends.

Based on the feature data, the trend information, and a processing type corresponding to the usage scene, the server constructs a prompt sentence. The server maintains a set of prompt templates for different tasks, such as recommendation, conversation support, empathetic response, and user matching. Each template contains placeholder fields for user-specific and context-specific data. The server fills the placeholders with values derived from the feature data and the trend information.

For example, when the processing type is content recommendation after a user has watched a video, the server may construct a prompt sentence such as:
“The user has just finished watching several science-fiction movies by a particular director and cannot decide the next movie. Based on the following viewing history: {viewing history summary}, recommend three similar movies and explain in one sentence why each recommendation matches the user's interests.”

When the processing type is emotion-aware conversation support, the server may construct a prompt sentence such as:
“The user has expressed sadness in the following message: ‘{user message}’. Generate a short, empathetic reply that acknowledges the emotion and gently invites further sharing.”

When the processing type is in-store product suggestion with a visual presentation device, the server may construct a prompt sentence such as:
“Customer interest: movies. Past purchase history: movie-related goods. Currently viewed shelf: new merchandise. Generate one concise product suggestion and one possible opening question for a salesperson.”

When the processing type is user matching, the server may construct a prompt sentence such as:
“User A and User B share the following common interests: {common interests}. Generate an introductory message and two conversation topics that help them start a friendly conversation.”

The server may impose structure on the prompt sentence by specifying expected output formats, such as numbered lists, bullet points, or key-value pairs, to facilitate subsequent parsing and mapping to internal identifiers.

The server transmits the constructed prompt sentence to a generative AI model. In one embodiment, the generative AI model is a transformer-based language model including multiple attention layers, layer normalization layers, and feed-forward layers. The generative AI model processes the prompt sentence to generate continuation text that contains, for example, candidate information, conversation topics, or response texts. The generative AI model may be hosted on a separate machine or cluster accessible via an API, or on the same server using a specialized serving framework.

The server configures parameters for the generative AI model invocation, such as maximum output length, temperature, and sampling strategy. By adjusting these parameters according to the processing type and context, the server can control the diversity and determinism of the generated outputs. For example, for critical instructional messages, the server may decrease temperature to reduce randomness, whereas for creative topic suggestions, the server may increase temperature within a bound.

After receiving the generated data from the generative AI model, the server parses the output. If the prompt sentence requested a structured output, the server checks conformity to the requested structure and may perform corrective parsing or secondary validation. The server then maps natural language references (such as content titles, product names, or category labels) to internal identifiers by querying the database or by using a similarity search module. The server may use an index of normalized titles or vector embeddings of item descriptions to efficiently retrieve matching internal entries.

By performing the mapping at the server, the system links the generative AI output to existing content and product catalogs, enabling the server to treat generated recommendations and topics as structured entities rather than free text. This mapping allows the server to apply technical constraints such as availability, access rights, or age restrictions before presenting the results to the user.

The server then generates output information to be transmitted to the terminal. The output information includes structured fields such as internal identifiers, display labels, thumbnails, and explanatory texts. The server can optimize the layout of the output information for each type of terminal. For example, for a smartphone, the server may limit the number of items and select short explanation texts, while for a head-mounted display, the server may provide concise overlays with minimal text.

The terminal receives the output information and renders it using its display unit. The terminal may present recommended content as a carousel of cards, conversation topics as selectable chips in a message input area, or product suggestions as augmented-reality overlays. The terminal records user operations on these outputs, such as which recommendation was selected, which conversation topic was used, or which suggestion was dismissed. The terminal sends these operation reports back to the server as part of the behavior information.

The server updates the feature data based on these new user operations. For example, if a user consistently selects certain genres or types of suggestions, the server increments weights associated with those categories in the feature vectors. If a user ignores certain kinds of recommendations, the server decreases the corresponding weights. Additionally, the server can analyze click-through rates or dwell times associated with prompts and generated outputs to measure effectiveness of different prompt templates.

In one embodiment, the server maintains a prompt history table storing each prompt sentence and corresponding model output, along with subsequent user engagement metrics. The server can periodically analyze this table to refine prompt templates. For instance, the server can learn that including explicit explanations of why an item is recommended increases acceptance rates, and can thus modify prompt templates to always request such explanations. This adaptive prompt optimization is a technical improvement over static prompt usage and reduces trial-and-error at the application level.

The described architecture produces technical effects in several ways. By converting heterogeneous logs and messages into unified feature data and by constructing prompt sentences that are tailored to this feature data, the server reduces the need for manual rule coding and decreases the amount of data that must be transmitted to the generative AI model, thereby reducing network load and latency. Because the prompt sentence encodes context in a compact but semantically rich format, the generative AI model can operate efficiently without direct access to raw logs or large histories.

Furthermore, the feature extraction and emotion recognition processes allow the server to pre-filter and compress information before it is used to control the generative AI model. This reduces computational overhead compared to approaches that attempt to feed entire histories or unprocessed data to a model. By mapping back natural language to internal identifiers at the server, the system maintains a consistent internal representation, which improves data management and enables fast lookups and updates in the database.

The system also improves accuracy and responsiveness of recommendations and conversational support because the server continuously updates the feature data and prompt generation logic based on observed user operations on the generated outputs. This feedback loop provides a non-conventional use of the generative AI model in which the server does not simply automate a human task, but instead integrates the model into a dynamic, context-aware control mechanism that optimizes prompts and output usage at runtime.

The server implements specific algorithms for similarity measurement and user matching. For example, the server may represent each user by a feature vector in a multi-dimensional space and compute cosine similarity between users. The server may perform approximate nearest-neighbor search using an indexing structure, which allows efficient identification of recommended users among a large user base. The server then uses the generative AI model to generate introduction texts and conversation-starting topics that are tailored to these similarity relationships. This combination of vector-space matching and generative text construction yields a technical improvement in how user matching data is processed and presented.

In another embodiment, the server applies different neural architectures for different sub-tasks. For recommendation, the server may use a factorization-based or sequence-based neural network, trained to predict likely next items from histories. The outputs of this recommendation network can be used both to update feature data and to inform prompt construction. For example, the server can pass top-N predicted items to the generative AI model as context, thus enabling the model to generate natural language explanations for algorithmic recommendations. This division of labor between specialized predictive models and a generative text model results in improved computational efficiency, because structured predictions can be obtained using relatively lightweight models, while text generation is reserved for presentation-oriented tasks.

The described system is not limited to any single hardware or software stack. A terminal may be implemented as an embedded device with a custom operating system, and the generative AI model may run on specialized accelerator hardware such as graphics processors or tensor processing units. The server may distribute different components across multiple physical machines, for example, separating the database, application logic, and model serving into different nodes. The communication between these nodes may use internal network protocols optimized for low latency.

In alternative embodiments, the server may implement rule-based pre-filters or post-filters around the generative AI model, such as content safety filters or domain-specific constraint checkers. These filters can be realized as deterministic algorithms operating on internal identifiers and structured attributes. By combining stochastic generative processing with deterministic rule-based processing, the server increases reliability, reduces error rates, and enforces technical constraints such as compliance with device capabilities or bandwidth limitations.

Because the server performs non-conventional transformations of input data into feature data, constructs context-dependent prompt sentences for a generative AI model, uses post-processing to map generated text into internal identifiers, and uses user operations on generated output to adapt future processing, the system improves the functioning of the underlying computer network and data processing infrastructure. The improvements include reduced network traffic to the generative model, faster generation cycles due to compact prompts, better cache utilization due to structured data mapping, and higher accuracy of recommendations and conversational support through closed-loop optimization.

The described embodiments are examples for illustrating how the invention can be implemented. The server may employ different neural network architectures, feature engineering techniques, prompt templates, or database schemas without departing from the scope of the claims. For example, the emotion recognition model may be replaced by a convolutional network, and the generative AI model may be replaced by a different sequence generation architecture. Likewise, similarity metrics for user matching may include Euclidean distance or learned metric embeddings. The fundamental technical concept remains that the server generates and uses prompt sentences, based on unified feature data and trend information, to control a generative AI model and to integrate its outputs into a structured, adaptive information processing pipeline.

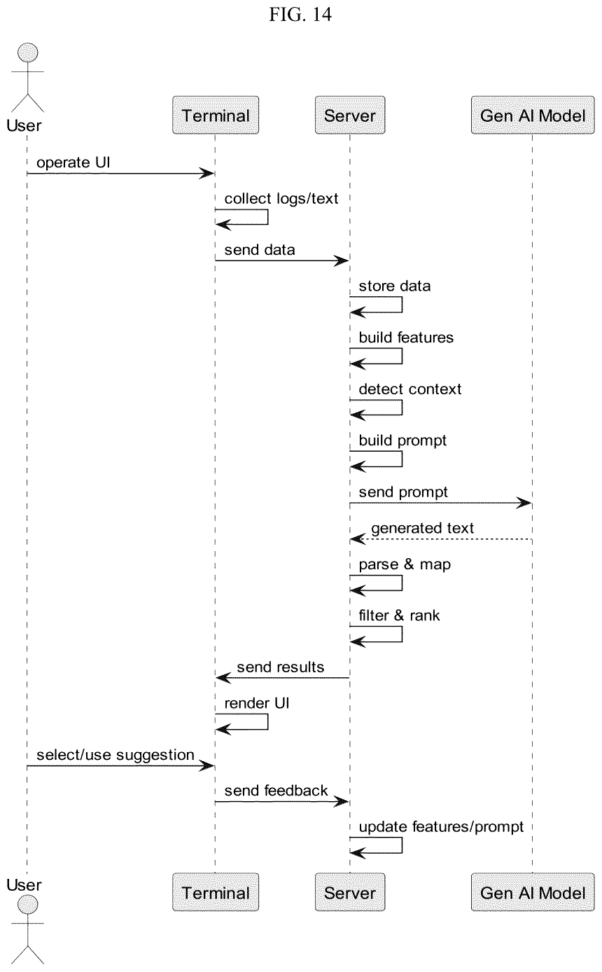

The following describes the processing flow using FIG. 14.

### Step 1:

The user operates the terminal.

The user views content, types messages, performs selection operations on recommendation lists, or walks in a physical environment while carrying or wearing the terminal.
Input: No digital input from prior system steps; this is human interaction.
Output: User operations such as taps, clicks, scrolls, message texts, and location-related events that the terminal can sense.

### Step 2:

The terminal collects behavior information and input information.

The terminal monitors the user interface and operating system events, detects operations such as selection operations, viewing durations, and transmission operations, and captures user-entered text in message fields or search boxes.
Input: Low-level UI and sensor events generated by the operating system and application framework.
Output: Structured records including at least a user identifier, terminal identifier, timestamp, screen identifier, operation type, content identifier, and input text when present.

### Step 3:

The terminal transmits the structured records to the server.

The terminal packages the behavior information and input information as messages (for example, JSON over HTTPS or frames over WebSocket), applies encryption if required, and sends the messages to a predefined server endpoint.
Input: Structured records produced in Step 2.
Output: Network messages delivered to the server, each containing one or more log entries and associated metadata.

### Step 4:

The server receives and stores the behavior information and input information.

The server accepts incoming network requests, parses message bodies, validates required fields, and inserts the parsed data into database tables such as a behavior log table and a message table.
Input: Network messages received from the terminal, including structured log entries.
Output: Persistent database records keyed by user identifier, timestamp, and other indices, enabling subsequent retrieval and aggregation.

### Step 5:

The server retrieves relevant historical data and user profiles.

The server executes database queries using the user identifier and time range derived from the newly received logs to obtain user profile data, past behavior logs, and past messages.
Input: User identifier and session context derived from the latest logs.
Output: A collection of historical records (for example, viewing history, purchase history, prior recommendations, and prior messages) loaded into memory as data structures.

### Step 6:

The server constructs and cleans a behavioral data frame.

The server loads the retrieved historical records and recent logs into a data-frame structure, filters records by relevance (for example, recent timeframe or specific screen types), removes corrupt or incomplete entries, and normalizes timestamp formats.
Input: Historical records and newly received logs from Step 5.
Output: A cleaned data frame containing standardized columns such as content category, operation type, dwell time, and time indices, ready for numerical processing.

### Step 7:

The server performs numerical aggregation and normalization to create behavior-based features.

The server groups the data frame by user and content category, computes statistics such as counts of operations, average dwell times, and recency scores, and then applies scaling operations (such as min-max scaling) to generate normalized behavior features.
Input: Cleaned data frame from Step 6.
Output: Behavior feature vectors that numerically represent user interest patterns, content preferences, and interaction intensities.

### Step 8:

The server analyzes user text to extract linguistic features.

The server selects recent user messages from the message table, tokenizes each message into words, removes stop words, and performs lemmatization using a natural language processing library. The server converts tokens into numerical representations, such as word embeddings.
Input: Raw text messages associated with the user.
Output: Token sequences and embedding vectors representing the semantic content of each message.

### Step 9:

The server estimates a user emotion label from the linguistic features.

The server feeds the embedding vectors into an emotion recognition neural network, computes activations across network layers, calculates probabilities for emotion classes such as joy, sadness, anger, and neutral, and selects the class with the highest probability as the emotion label.
Input: Embedding vectors and network parameters of the emotion model.
Output: An emotion label and an associated confidence score stored in memory and optionally in the database.

### Step 10:

The server assembles unified feature data for the current context.

The server combines the behavior feature vectors, the emotion label, profile attributes (for example, age or declared preferences), and session parameters (for example, current screen type, device type) into a single feature object or composite vector.
Input: Behavior features from Step 7, emotion label from Step 9, and profile data from the database.
Output: Unified feature data representing the user's current state and longer-term patterns.

### Step 11:

The server acquires and merges trend information with the unified feature data.

The server retrieves current trend data (for example, trending content categories or popular products) from local tables or external APIs and matches trend items to user-related categories in the unified feature data.
Input: Unified feature data from Step 10 and trend records from internal or external sources.
Output: An augmented feature object that includes both user-specific characteristics and trend-based signals for use in subsequent decision making.

### Step 12:

The server determines a processing type for the current session.

The server inspects the latest behavior information, such as screen identifier and recent operations, and selects a processing type such as content recommendation, conversation support, empathetic reply, user matching, or in-store suggestion.
Input: Session metadata derived from recent logs and unified feature data.
Output: A processing type flag (for example, “RECOMMENDATION_SCI_FI_MOVIE” or “EMPATHY_REPLY”) that guides prompt construction.

### Step 13:

The server selects a prompt template corresponding to the processing type.

The server accesses a configuration store of prompt templates, filters templates by processing type and language, and retrieves the template that best matches the current context.
Input: Processing type flag from Step 12 and configuration of prompt templates.
Output: A template string or structured template with placeholders for user-specific and context-specific values.

### Step 14:

The server fills the prompt template with context data to generate a prompt sentence.

The server replaces placeholders in the selected template with values from the augmented feature object, such as summarized viewing history, recognized emotion, common interests, or current shelf description, and then concatenates or formats these elements into a coherent natural-language prompt sentence.
Input: Prompt template from Step 13 and augmented feature data from Step 11.
Output: A fully instantiated prompt sentence that specifies the type and constraints of data to be generated by the generative AI model.

### Step 15:

The server transmits the prompt sentence to the generative AI model.

The server constructs an API request including the prompt sentence and control parameters such as maximum token count and randomness level, then sends the request to a generative AI model service and waits for a response.
Input: Prompt sentence from Step 14 and model invocation parameters.
Output: A request message transmitted to the generative AI model and a pending state on the server awaiting generated data.

### Step 16:

The generative AI model produces generated data in response to the prompt sentence.

The generative AI model processes the input prompt sentence through multiple attention and feed-forward layers, predicts subsequent tokens, and returns generated text that may include recommended items, conversation topics, empathetic responses, or introduction messages.
Input: Prompt sentence and model parameters internal to the generative AI model.
Output: Generated data as a text sequence or structured text response returned to the server.

### Step 17:

The server receives and parses the generated data.

The server extracts the text payload from the model response, analyzes formatting (for example, numbered list or delimited fields), and segments the text into units such as individual recommendations, topics, or sentences.
Input: Generated text returned by the generative AI model.
Output: Parsed components representing distinct elements such as candidate items, explanation sentences, or proposed messages.

### Step 18:

The server maps natural-language references in the generated data to internal identifiers.

The server compares item descriptions or titles in the generated text with entries in its content and product databases using exact matching, normalized string matching, or vector similarity; it then assigns each matched element an internal identifier corresponding to a known content or product record.
Input: Parsed generated elements from Step 17 and database entries with associated metadata.
Output: A structured representation linking each generated recommendation or reference to a specific internal identifier.

### Step 19:

The server applies selection and filtering logic to the mapped results.

The server evaluates each mapped element against constraints such as availability, user access rights, age restrictions, or device-specific limitations, and discards items that do not satisfy constraints. The server may also rank the remaining items according to relevance scores or business rules.
Input: Structured mapped results from Step 18 and constraint rules stored in configuration or database tables.
Output: A filtered and ordered set of items and texts suitable for presentation to the user.

### Step 20:

The server constructs output information for the terminal.

The server assembles the filtered items into a response object that includes internal identifiers, display texts, thumbnails, short explanations, and any conversation-starter texts, formatted according to the target terminal type and screen layout.
Input: Filtered and ranked elements from Step 19 and presentation configuration data.
Output: Output information structured for efficient rendering on the terminal.

### Step 21:

The server transmits the output information to the terminal.

The server serializes the output information into a response message, sends it over the network to the terminal, and records the association between the sent content and the corresponding prompt sentence and feature data in a prompt history table.
Input: Output information from Step 20.
Output: Network response to the terminal and updated history records stored on the server.

### Step 22:

The terminal renders the output information on its display.

The terminal decodes the received response, creates user interface elements such as cards, suggestion chips, or overlays, and draws them on the message exchange screen, recommendation screen, or visual presentation screen.
Input: Output information received from the server.
Output: Visible user interface components presenting recommendations, topics, or messages to the user.

### Step 23:

The user interacts with the presented information.

The user selects a recommended item, chooses a conversation-starting topic, edits and sends a suggested response, or ignores certain suggestions.
Input: Displayed UI elements on the terminal.
Output: New user operations such as selections, message transmissions, or dismissals, which the terminal can detect as events.

### Step 24:

The terminal records and reports user operations on the generated outputs.

The terminal logs which elements were selected, which were ignored, and how long they were viewed, associates these logs with identifiers included in the output information, and sends the logs back to the server as updated behavior information.
Input: Low-level interaction events with UI elements related to the generated outputs.
Output: Behavior information that details user engagement with specific generated recommendations or topics.

### Step 25:

The server updates feature data based on the new behavior information.

The server ingests the new logs, identifies which generated items or topics were accepted or rejected, adjusts interest weights and engagement scores accordingly, and modifies the unified feature data to reflect the updated user preferences and responsiveness.
Input: Behavior information received from Step 24 and previously stored feature data.
Output: Updated feature data that more accurately represents the user's current interests and preferred interaction styles.

### Step 26:

The server refines prompt generation logic using accumulated history.

The server analyzes stored prompt sentences, corresponding generated outputs, and associated engagement metrics, identifies template patterns that lead to high or low engagement, and updates prompt templates or parameter settings so that future prompt sentences emphasize more effective wording and structure.
Input: Prompt history records, engagement statistics, and current prompt templates.
Output: Revised prompt templates and generation rules that influence the content and structure of future prompt sentences.

### Step 27:

The server prepares for subsequent cycles of interaction.

The server keeps the updated feature data, refined prompt templates, and recent interaction history in memory or fast storage so that subsequent requests from the same user can be processed with reduced latency and improved accuracy.
Input: Updated feature data and refined templates from Steps 25 and 26.
Output: A ready state in which the server can generate new prompt sentences and interact with the generative AI model more efficiently in subsequent processing cycles.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

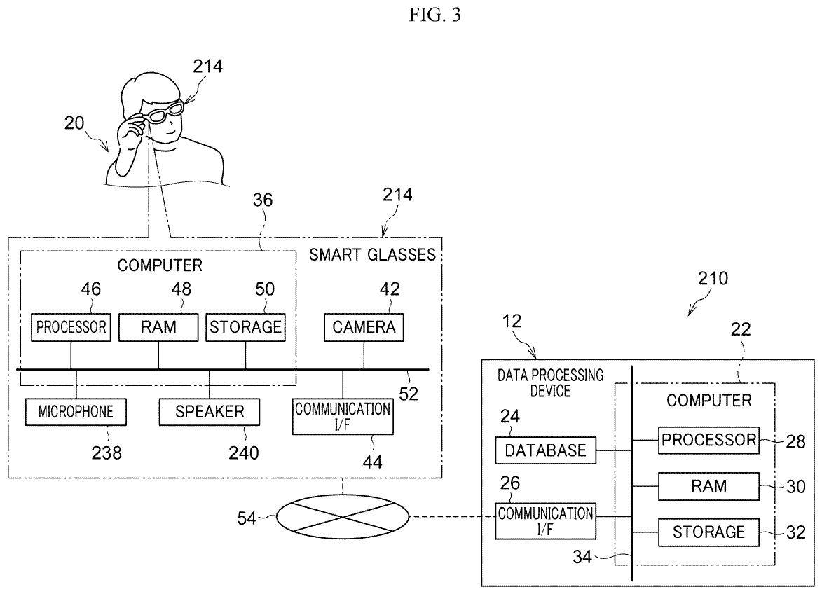

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

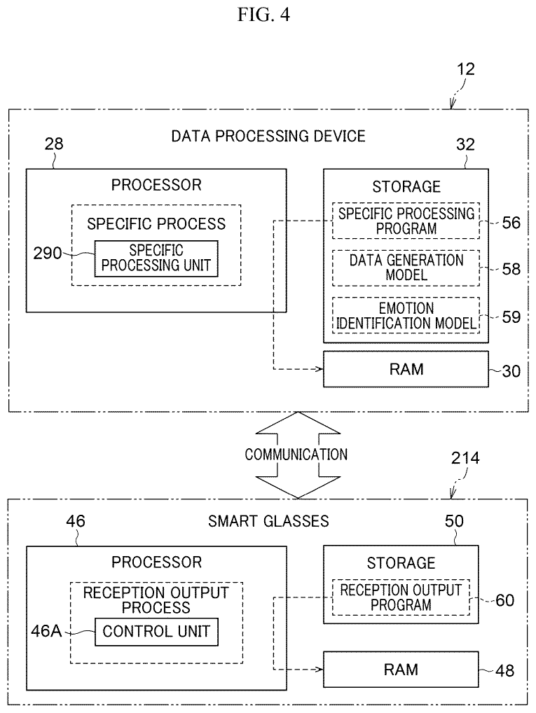

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

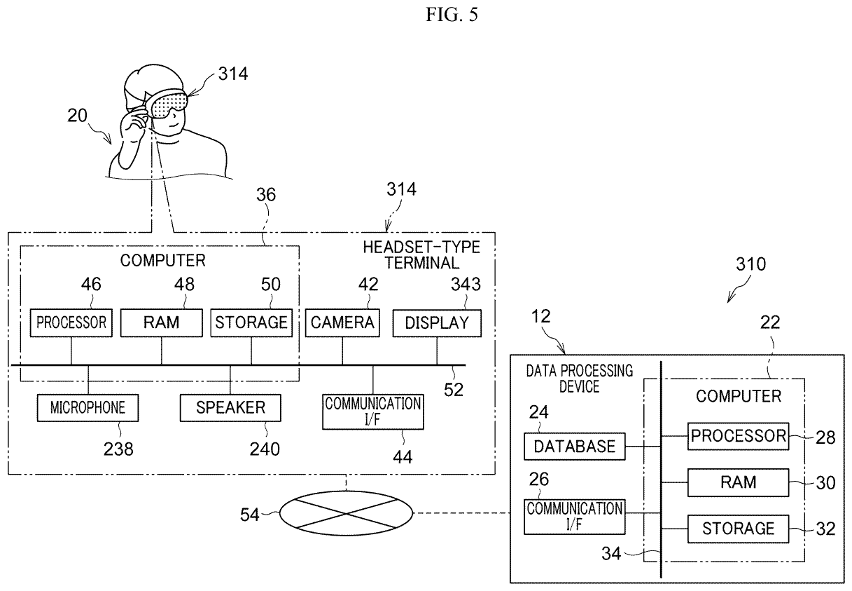

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

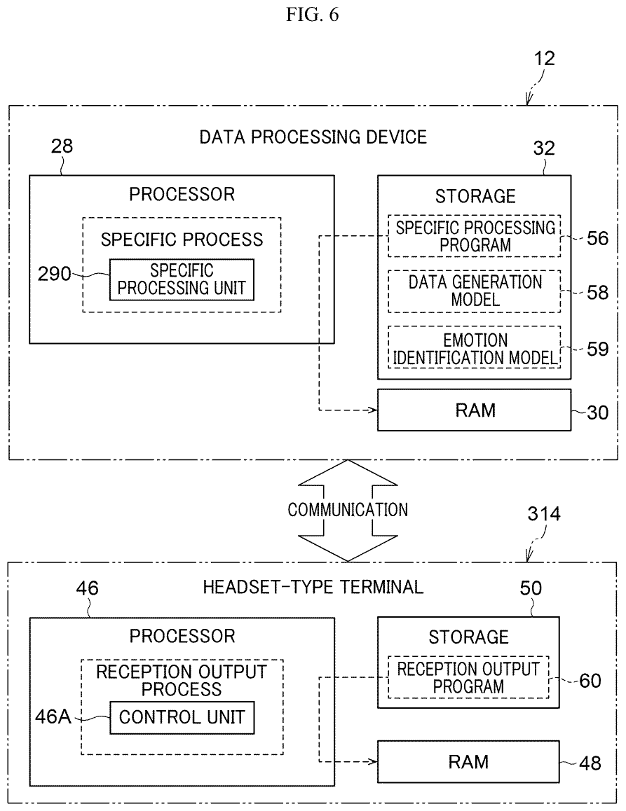

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

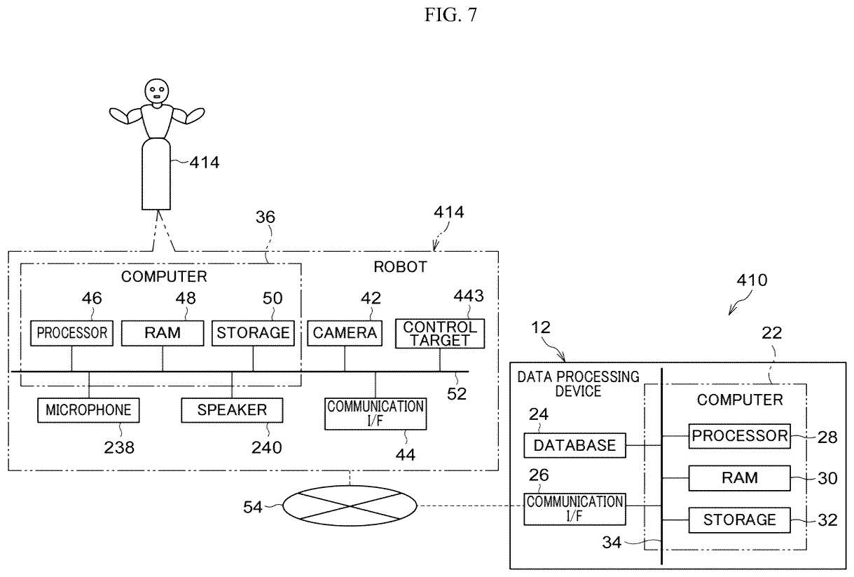

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

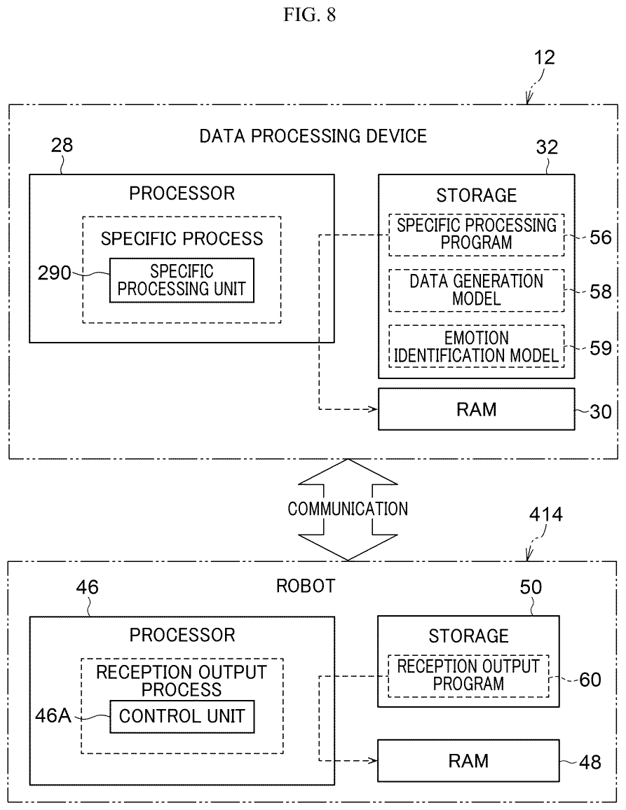

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

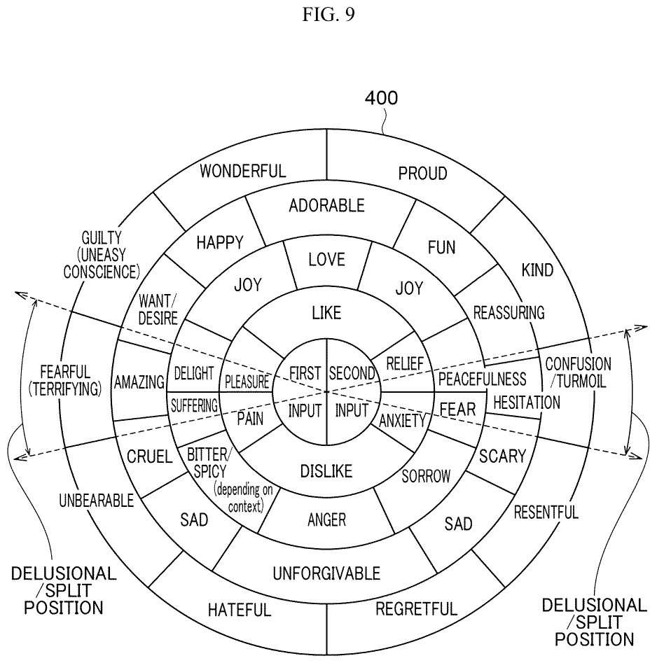

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

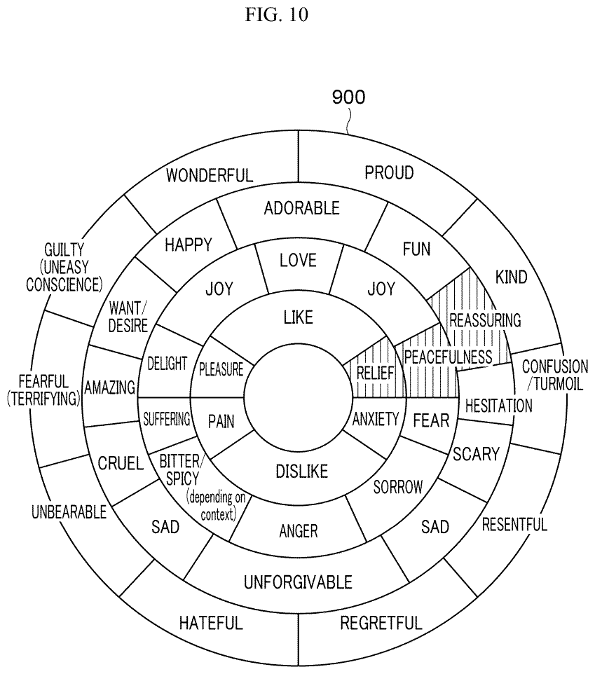

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a communication interface, a storage device, and a display device,
wherein the processor is configured to control a terminal to present an input display area on the display device, detect a user operation in the input display area, acquire text information input by a user, and generate transmission request data including the text information and destination identification information,
wherein the processor is configured to cause the terminal to transmit the transmission request data to an information processing apparatus via a communication protocol through the communication interface, receive response data from the information processing apparatus, and output message information included in the response data to the display device while executing a notification process,
wherein the processor is configured to cause the information processing apparatus to receive the transmission request data from the terminal, analyze a request content of the transmission request data, extract source user identification information, destination user identification information, and message content information from the transmission request data, and store the extracted information in a data structure in a memory of the information processing apparatus,
wherein the processor is configured to generate a prompt sentence that instructs a generative processing apparatus to generate data required for information exchange, based on the analyzed message content information and user-related information stored in the storage device, and to input the prompt sentence into the generative processing apparatus,
wherein the processor is configured to cause the information processing apparatus to obtain information exchange data generated by the generative processing apparatus in response to the prompt sentence, associate the information exchange data with the data structure, store the information exchange data and message history information in the storage device, and manage user state information in the storage device,
wherein the processor is configured to determine, based on the destination user identification information, a connection state of a destination user by referring to connection management information, to transmit the information exchange data to a destination terminal by real-time communication control via the communication interface when the destination user is in a connected state, to hold the information exchange data as undelivered information in the storage device when the destination user is in a disconnected state, and, upon establishment of a connection from the destination terminal, to acquire the undelivered information from the storage device and transmit the undelivered information in bulk or sequentially to the destination terminal, and
wherein the processor is configured to cause the terminal to receive the information exchange data from the information processing apparatus via the communication interface, store the information exchange data in a local storage of the terminal, and update a conversation display area on the display device so as to present the message information visually to the user.

### Supplementary 2

The system according to supplementary 1,
wherein the processor is configured to cause the information processing apparatus to analyze a plurality of message history information and user attribute information stored in the storage device, extract shared-target information from the plurality of message history information and the user attribute information, generate, as the prompt sentence, an instruction to the generative processing apparatus for generating sharable information between users based on the shared-target information, and, using data for sharing generated by the generative processing apparatus in response to the prompt sentence, store the data for sharing in the storage device and distribute the data for sharing to a plurality of destination users.

### Supplementary 3

The system according to supplementary 1,
wherein the processor is configured to cause the information processing apparatus to acquire interest attribute information and environment condition information registered for each user from the storage device, perform evaluation processing regarding similarity between users based on selection conditions of a user, detect recommended users determined to have a common interest based on the evaluation processing, generate, as the prompt sentence, an instruction to the generative processing apparatus for creating information that promotes information exchange between the recommended users, and, using recommended-user data generated by the generative processing apparatus in response to the prompt sentence, store the recommended-user data in the storage device and distribute the recommended-user data to the recommended users.

### Application Example 1

### Supplementary 1

A system comprising a processor and a storage device,
wherein the processor is configured to
analyze character information acquired from a user terminal, and determine, on the basis of the character information and past usage history corresponding to a user, whether the user is in a situation in which the user lacks a conversation opener,
construct a prompt sentence, on the basis of a result of the determination and the past usage history, the prompt sentence including instructions to generate a topic serving as a conversation opener and data to be used for information exchange, and input the prompt sentence to a generative AI model to cause the generative AI model to generate the topic and the data,
acquire the past usage history from an information accumulation device that stores the usage history of the user, and extract recommendation information in accordance with a preference of the user on the basis of a generation result obtained from the generative AI model and the past usage history,
analyze reference information indicating a location of an information resource included in the character information, acquire additional information from the information resource corresponding to the reference information, and generate display data for causing the additional information to be displayed on the user terminal, and
store, in the storage device, the topic generated by the generative AI model, the data to be used for information exchange, the recommendation information, and the display data, and transfer the topic, the data, the recommendation information, and the display data to the user terminal.

### Supplementary 2

The System According to Supplementary 1,
wherein the processor is configured to construct the prompt sentence in a format that hierarchically describes context information including past behavior history of the user, recent dialogue history, and current input character information, and to cause the generative AI model, by means of the prompt sentence, to simultaneously generate a plurality of candidate topics serving as conversation openers and candidate information recommendations consistent with the preference of the user.

### Supplementary 3

The system according to supplementary 1,
wherein the processor is configured to include, in the prompt sentence, a description specifying an output format so that a generation result output from the generative AI model has a machine-readable structured format, to parse the generation result in accordance with the output format, and to distinguish and present, to the user terminal, the topic serving as the conversation opener, the data to be used for information exchange, the recommendation information, and the display data.

### Example 2

### Supplementary 1

A system comprising a processor and a storage device,
wherein the processor is configured to
obtain, based on a user identifier, communication history information from the storage device and extract transmission time information and content information included in the communication history information,
calculate statistical values and feature values based on the communication history information and generate behavior pattern information indicating a behavior tendency of the user in information exchange,
output a detection result indicating a situation in which the user lacks a conversational opening and has not transmitted information for a predetermined period, based on screen state information and input state information transmitted from a terminal and the behavior pattern information,
construct a prompt sentence that instructs generation of a topic serving as a conversational opening that the user can transmit, based on the detection result, the behavior pattern information, and recent communication history information,
input the prompt sentence to a generative artificial intelligence model and cause the generative artificial intelligence model to generate information-exchange data including a topic candidate by numerical computation processing, and
store the generated information-exchange data in the storage device and transmit the information-exchange data as notification information to the terminal to present the information-exchange data to the user.

### Supplementary 2

The system according to supplementary 1,
wherein the processor is configured to
include, as the behavior pattern information, feature values indicating message transmission frequency, response interval, and a field of interest of the user, and variably set a topic type, a writing style, and a number of suggestions in the prompt sentence in accordance with the feature values.

### Supplementary 3

The system according to supplementary 1,
wherein the processor is configured to
determine, based on the detection result, dialog-form information indicating whether a dialogue is one-to-one or multi-party and whether the dialogue is business-oriented or private, and include the dialog-form information in the prompt sentence so as to cause the generative artificial intelligence model to generate the information-exchange data including a conversation-starting message adapted to the dialog form.

### Application Example 2

### Supplementary 1

A system comprising a processor and a storage device,
wherein the processor is configured to
receive behavior information and input information from a user terminal, analyze the behavior information and the input information, and generate feature data indicating at least a user interest, a user history, a user emotion, and a current usage context,
generate a prompt sentence, based on the feature data, trend information acquired from an external information source, and a processing type corresponding to a usage scene, the prompt sentence defining contents of data to be generated for at least one of information exchange, decision-making support, and conversation support,
input the prompt sentence to a generative AI model and obtain generated data including at least one of candidate information to be presented to the user, a topic for starting a conversation, a response text, recommendation target information, and an explanation text, store the generated data in the storage device in association with the user, convert a natural language expression included in the generated data into an internal identifier, and process the generated data into output information that is presentable to the user,
transmit the output information to the user terminal and cause the user terminal to display the output information via at least one of a message exchange screen, a recommendation screen, and a visual presentation device, and
receive, as part of the behavior information, at least one of a selection operation, a viewing operation, and a transmission operation performed by the user on the output information, and update at least one of the feature data and generation of the prompt sentence based on the received behavior information.

### Supplementary 2

The system according to supplementary 1,
wherein the processor is configured to
estimate an emotion label from the input information by natural language processing, and, in generating the prompt sentence, include a description instructing generation of at least one of an empathetic response, emotion-matched content, and a topic candidate in accordance with the emotion label.

### Supplementary 3

The system according to supplementary 1,
wherein the processor is configured to
detect a recommended user having at least one of a common interest and a similar behavior pattern among a plurality of users based on the feature data of the plurality of users, generate in the prompt sentence an instruction to create an introduction text and a conversation-starting topic for initiating information exchange between the recommended users by the generative AI model, and transmit the introduction text and the conversation-starting topic obtained from the generative AI model to respective user terminals of the recommended users.

What is claimed is:

1. A system comprising:
circuitry configured to:
receive input data from a terminal apparatus via a packet-switched network;
analyze the input data by applying a natural language processing algorithm to extract content information and context information from the input data;
construct a parameterized instruction sequence based on the content information, the context information, and attribute data associated with a source entity, the parameterized instruction sequence specifying a generation task for a generative neural network model;
provide the parameterized instruction sequence to the generative neural network model to cause the generative neural network model to generate structured output data; and
store the structured output data in a storage medium and transmit the structured output data to a destination terminal apparatus via the packet-switched network.

2. The system according to claim 1, wherein the circuitry is further configured to:
extract from the input data source entity identification information, destination entity identification information, and message content information, and store the extracted information in a data structure in association with the source entity identification information.

3. The system according to claim 2, wherein the circuitry is further configured to:
determine a connection state of the destination entity by referring to connection management information stored in the storage medium, transmit the structured output data to the destination terminal apparatus by real-time communication control when the destination entity is in a connected state, and hold the structured output data as undelivered information in the storage medium when the destination entity is in a disconnected state.

4. The system according to claim 3, wherein the circuitry is further configured to:
upon establishment of a connection from the destination terminal apparatus, acquire the undelivered information from the storage medium and transmit the undelivered information to the destination terminal apparatus.

5. The system according to claim 4, wherein the circuitry is further configured to:
analyze a plurality of message history records and attribute data records stored in the storage medium, extract shared-target information from the plurality of message history records and the attribute data records, and incorporate the shared-target information into the parameterized instruction sequence to cause the generative neural network model to generate distributable content data, and distribute the distributable content data to a plurality of destination terminal apparatuses.

6. The system according to claim 5, wherein the circuitry is further configured to:
acquire interest attribute data and environment condition data registered for each entity from the storage medium, perform similarity evaluation processing between entities based on the interest attribute data and selection condition data of a requesting entity, and identify candidate entities determined to have overlapping interest attribute data based on the similarity evaluation processing.

7. The system according to claim 6, wherein the similarity evaluation processing comprises computing vector representations of the interest attribute data for each entity using an embedding model, calculating pairwise similarity scores between the vector representations using a distance metric, and selecting entities having similarity scores exceeding a predetermined threshold.

8. The system according to claim 7, wherein the circuitry is further configured to:
construct a supplementary parameterized instruction sequence incorporating the interest attribute data of the identified candidate entities and the selection condition data, and provide the supplementary parameterized instruction sequence to the generative neural network model to generate introductory content data, and transmit the introductory content data to terminal apparatuses associated with the identified candidate entities.

9. The system according to claim 5, wherein the circuitry is further configured to:
analyze character string data acquired from the terminal apparatus and past usage history data corresponding to the source entity to determine whether the source entity is in a context requiring supplementary content generation, and construct the parameterized instruction sequence to include instructions for generating topic data and supplementary exchange data based on the past usage history data.

10. The system according to claim 9, wherein the circuitry is further configured to:
extract preference information from the past usage history data, and generate recommendation data in accordance with the preference information based on a generation result obtained from the generative neural network model and the past usage history data.

11. The system according to claim 10, wherein the parameterized instruction sequence is constructed in a format that hierarchically describes context information including past behavior history of the source entity, recent interaction history, and current input character string data, such that the generative neural network model simultaneously generates a plurality of candidate topic data items and candidate recommendation data items consistent with the preference information.

12. The system according to claim 10, wherein the circuitry is further configured to:
analyze reference information indicating a location of an information resource included in the character string data, acquire additional information from the information resource corresponding to the reference information via the packet-switched network, and generate display data for presenting the additional information on the terminal apparatus.

13. The system according to claim 9, wherein the generative neural network model comprises a transformer-based architecture including a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

14. The system according to claim 13, wherein the circuitry is further configured to:
obtain, based on a source entity identifier, communication history information from the storage medium, extract transmission time information, reception time information, and content length information from the communication history information, compute statistical feature values including a transmission frequency, a mean response interval, and a mean content length, and store the statistical feature values as behavioral profile data in the storage medium.

15. The system according to claim 14, wherein the circuitry is further configured to:
apply a classification model to the behavioral profile data, the classification model having an input layer corresponding to dimensions of the statistical feature values, one or more hidden layers with non-linear activation functions, and an output layer that computes probability distributions over a set of behavioral category labels, and determine a behavioral category for the source entity based on output probabilities of the classification model.

16. The system according to claim 15, wherein the circuitry is further configured to:
select a parameterized instruction sequence template from a plurality of stored templates based on the determined behavioral category, and populate the selected template with the content information and the behavioral profile data to construct the parameterized instruction sequence.

17. The system according to claim 16, wherein the parameterized instruction sequence includes a description specifying an output format such that a generation result from the generative neural network model has a machine-readable structured format, and wherein the circuitry parses the generation result in accordance with the output format to distinguish and separately store topic data, exchange content data, recommendation data, and display data.

18. A system comprising:
circuitry configured to:
receive, via a communication interface coupled to a packet-switched network, input data from a terminal apparatus;
analyze the input data by applying a natural language processing algorithm to extract content information and context information, and extract source entity identification information and destination entity identification information from the input data;
construct a parameterized instruction sequence based on the content information, the context information, attribute data associated with the source entity, and communication history information stored in a storage medium;
provide the parameterized instruction sequence to a generative neural network model having a transformer-based architecture including a plurality of self-attention layers to cause the generative neural network model to generate structured output data;
store the structured output data in the storage medium in association with the source entity identification information and the destination entity identification information; and
transmit the structured output data to a destination terminal apparatus via the packet-switched network based on a connection state of a destination entity.

19. The system according to claim 18, wherein the circuitry is further configured to:
acquire interest attribute data for a plurality of entities from the storage medium, compute similarity scores between entities based on vector representations of the interest attribute data, identify candidate entities having similarity scores exceeding a threshold, construct a supplementary parameterized instruction sequence incorporating interest attribute data of the identified candidate entities, and provide the supplementary parameterized instruction sequence to the generative neural network model to generate introductory content data for distribution to terminal apparatuses associated with the identified candidate entities.

20. A method performed by circuitry, the method comprising:
receiving input data from a terminal apparatus via a packet-switched network;
analyzing the input data by applying a natural language processing algorithm to extract content information and context information from the input data;
constructing a parameterized instruction sequence based on the content information, the context information, and attribute data associated with a source entity, the parameterized instruction sequence specifying a generation task for a generative neural network model;
providing the parameterized instruction sequence to the generative neural network model to cause the generative neural network model to generate structured output data; and
storing the structured output data in a storage medium and transmitting the structured output data to a destination terminal apparatus via the packet-switched network.
